(19) United States
(12) Patent Application Publication
(10) Pub. No.: US 2021/0117244 A1
(43) Pub. Date: Apr. 22, 2021

(54) RESOURCE MANAGER ACCESS CONTROL

(71) Applicant: Intel Corporation, Santa Clara, CA (US)

(72) Inventors: Andrew J. HERDRICH, Hillsboro, OR (US); Priya AUTEE, Chandler, AZ (US); Rajesh M. SANKARAN, Portland, OR (US); Gilbert NEIGER, Portland, OR (US); Scott OEHRLEIN, Gilbert, AZ (US); Michael PRINKE, Aloha, OR (US); Ravi IYER, Portland, OR (US); Edwin VERPLANKE, Chandler, AZ (US)

(21) Appl. No.: 17/134,327

(22) Filed: Dec. 26, 2020

(51) Int. Cl. G06F 9/50; G06F 9/455; G06F 9/30

(52) U.S. Cl. CPC G06F 9/5077; G06F 9/5027; G06F 2009/45591; G06F 9/30101; G06F 9/45558

(57) ABSTRACT

Examples provide a system that includes one or more processors, that when operational, are to: based on content in a request being within a permitted range for a virtualized execution environment, transfer the request from the virtualized execution environment to reserve one or more device resources independent from causing a virtual machine exit to request to reserve one or more device resources. In some examples, the transfer comprises a write to a register. In some examples, processor-executed microcode is to determine whether content in the request is within a permitted range for the virtualized execution environment.

### BACKGROUND

Virtualization is a pervasive technology whereby applications and services execute in an isolated environment and share use of device resources. As multithreaded and multicore platform architectures continue to evolve, there are workloads running in a single-threaded, multithreaded, or complex virtualized environments with many collaboratively operating virtual machines, such as in Network Function Virtualization (NFV). In such deployments, the last level cache (LLC) and memory bandwidth are key resources to monitor, manage and use to ensure the performance and runtime determinism of the workloads present. With NFV, meeting Service Level Objectives (SLOs) with predictable performance is a key requirement.

One of the current trends in data center architectures is disaggregation of resources from the server level to the data center level. Intel® Resource Director Technology is a collection of technologies that provide visibility of available shared resources and control over shared resources such as Last Level Cache (LLC) and Memory Bandwidth. Shared resources such as the Last Level Cache and Memory Bandwidth can be used by applications, virtual machines and containers.

In some situations, RDT cannot be accessed by guest virtual machines or containers if virtual machines or containers lack root level privilege. A host system can perform monitoring for virtual machines (VMs) and containers and perform resource allocation to VMs and containers.

A virtualization hardware extension can be setup by a Virtual Machine Monitor or Manager (VMM) to enable guest software to access Model Specific Registers (MSR) associated with RDT directly. With MSR bitmaps enabled, the VMM can allow a guest to control the RDT related registers. Guest access to RDT without MSR bitmaps enabled could cause a vmexit, causing the host to patch a request and return a value. However, sharing the RDT infrastructure (and therefore the shared resources) by applications or VMs may not occur if the application or VM is not bounded in its use of shared resources. In some cases, accesses to MSR bitmaps may not be monitored by the VMM and host software may not be aware of configuration of the RDT registers being a form of denial of service attack.

In some cases, resources can be shared using paravirtualization, which provides modification of the guest to inform the VMM that it requests a service or requests to configure a shared resource. To access RDT registers, guest software may utilize an application program interface (API) call (e.g., hypercall) into the VMM to request a change to an RDT register. If RDT registers are read/written by the Operating System scheduler critical path, the guest Operating System stalls or cannot make forward progress until the result of the API call into the VMM returns a value. Stalling an Operating System operation can degrade system performance.

In some cases, VMMs could create a software model of the RDT architecture. The VMM could decide to isolate, share, or oversubscribe shared resources with a VM or container (and applications running therein). The VMM can maintain a mapping of the virtual RDT resources to the real RDT resources. Accesses from a guest VM to RDT registers could result in an exit (e.g., vmexit) and the VMM could evaluate the exit request and consult a remapping table to determine whether to permit a resource allocation and access to the RDT registers. The VMM can access the RDT and provide a result before allowing the guest VM to resume execution (e.g., vmenter). However, using a vmexit and vmenter sequence for each RDT register access could introduce latency.

A VMM could be modified to either support paravirtualization or utilize model-specific register (MSR) bitmaps to enable an application, VM or container to access RDT functionality. Paravirtualization could involve a modification of the guest virtual machine to utilize VMM extensions that provide a redirection to the host. MSR bitmaps can enable direct access to the RDT registers but may not allow the host or VMM to monitor which guest virtual machine is accessing the RDT registers and limit usage by any guest virtual machine to prevent excessive usage.

### BRIEF DESCRIPTION OF THE DRAWINGS

FIG. 1 is a simplified diagram of at least one embodiment of a data center for executing workloads with disaggregated resources.

FIG. 2 is a simplified diagram of at least one embodiment of a pod that may be included in a data center.

FIG. 3 is a simplified block diagram of at least one embodiment of a top side of a node.

FIG. 4 is a simplified block diagram of at least one embodiment of a bottom side of a node.

FIG. 5 is a simplified block diagram of at least one embodiment of a compute node.

FIG. 6 is a simplified block diagram of at least one embodiment of an accelerator node usable in a data center.

FIG. 7 is a simplified block diagram of at least one embodiment of a storage node usable in a data center.

FIG. 8 is a simplified block diagram of at least one embodiment of a memory node usable in a data center.

FIG. 9 depicts a system for executing one or more workloads.

FIG. 10 depicts an example system.

FIG. 11 shows an example system.

FIG. 12 depicts an example system that provides access to a resource manager to virtual machines.

FIG. 13 depicts an example computing system.

FIG. 14 depicts an example process.

FIG. 15 depicts a system.

FIG. 16 depicts an example of a data center.

### DETAILED DESCRIPTION

### Example Environment

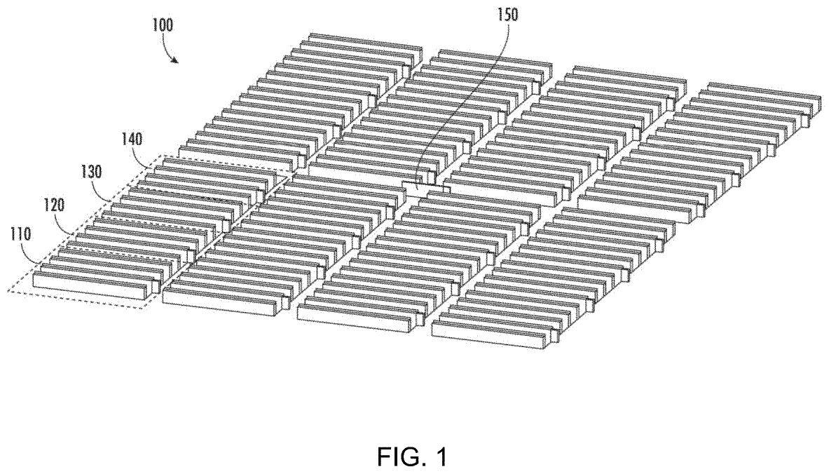

FIG. 1 depicts a data center in which disaggregated resources may cooperatively execute one or more workloads (e.g., applications on behalf of customers) includes multiple pods 110, 70, 130, 80, a pod being or including one or more rows of racks. Of course, although data center 100 is shown with multiple pods, in some embodiments, the data center 100 may be embodied as a single pod. As described in more detail herein, each rack houses multiple nodes, some of which may be equipped with one or more type of resources (e.g., memory devices, data storage devices, accelerator devices, general purpose processors). Resources can be logically coupled to form a composed node or composite node, which can act as, for example, a server to perform a job, workload or microservices.

An application can be composed of microservices, where each microservice runs in its own process and communicates using protocols (e.g., an HTTP resource API, message service, remote procedure calls (RPC), or gRPC). Microservices can be independently deployed using centralized management of these services. The management system may be written in different programming languages and use different data storage technologies. A microservice can be characterized by one or more of: use of fine-grained interfaces (to independently deployable services), polyglot programming (e.g., code written in multiple languages to capture additional functionality and efficiency not available in a single language), or lightweight container or virtual machine deployment, and decentralized continuous microservice delivery.

In the illustrative embodiment, the nodes in each pod 110, 70, 130, 80 are connected to multiple pod switches (e.g., switches that route data communications to and from nodes within the pod). The pod switches, in turn, connect with spine switches 90 that switch communications among pods (e.g., the pods 110, 70, 130, 80) in the data center 100. In some embodiments, the nodes may be connected with a fabric using Intel® Omni-Path technology. In other embodiments, the nodes may be connected with other fabrics, such as InfiniBand or Ethernet. As described in more detail herein, resources within nodes in the data center 100 may be allocated to a group (referred to herein as a “managed node”) containing resources from one or more nodes to be collectively utilized in the execution of a workload. The workload can execute as if the resources belonging to the managed node were located on the same node. The resources in a managed node may belong to nodes belonging to different racks, and even to different pods 110, 70, 130, 80. As such, some resources of a single node may be allocated to one managed node while other resources of the same node are allocated to a different managed node (e.g., one processor assigned to one managed node and another processor of the same node assigned to a different managed node).

A data center comprising disaggregated resources, such as data center 100, can be used in a wide variety of contexts, such as enterprise, government, cloud service provider, and communications service provider (e.g., Telcos), as well in a wide variety of sizes, from cloud service provider mega-data centers that consume over 60,000 sq. ft. to single- or multi-rack installations for use in base stations.

The disaggregation of resources to nodes comprised predominantly of a single type of resource (e.g., compute nodes comprising primarily compute resources, memory nodes containing primarily memory resources), and the selective allocation and deallocation of the disaggregated resources to form a managed node assigned to execute a workload improves the operation and resource usage of the data center 100 relative to typical data centers comprised of hyperconverged servers containing compute, memory, storage and perhaps additional resources in a single chassis. For example, because nodes predominantly contain resources of a particular type, resources of a given type can be upgraded independently of other resources. Additionally, because different resources types (processors, storage, accelerators, etc.) typically have different refresh rates, greater resource utilization and reduced total cost of ownership may be achieved. For example, a data center operator can upgrade the processors throughout their facility by only swapping out the compute nodes. In such a case, accelerator and storage resources may not be contemporaneously upgraded and, rather, may be allowed to continue operating until those resources are scheduled for their own refresh. Resource utilization may also increase. For example, if managed nodes are composed based on requirements of the workloads that will be running on them, resources within a node are more likely to be fully utilized. Such utilization may allow for more managed nodes to run in a data center with a given set of resources, or for a data center expected to run a given set of workloads, to be built using fewer resources.

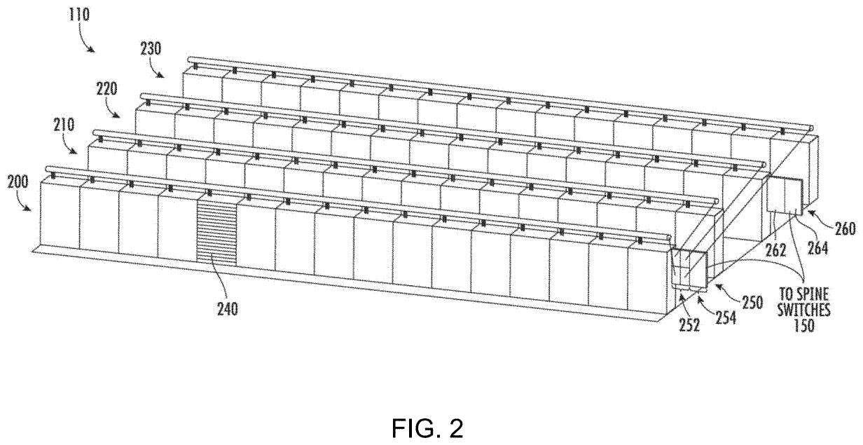

FIG. 2 depicts a pod. A pod can include a set of rows 200, 210, 220, 230 of racks 240. Each rack 240 may house multiple nodes (e.g., sixteen nodes) and provide power and data connections to the housed nodes, as described in more detail herein. In the illustrative embodiment, the racks in each row 200, 210, 220, 230 are connected to multiple pod switches 250, 260. The pod switch 250 includes a set of ports 252 to which the nodes of the racks of the pod 110 are connected and another set of ports 254 that connect the pod 110 to the spine switches 90 to provide connectivity to other pods in the data center 100. Similarly, the pod switch 260 includes a set of ports 262 to which the nodes of the racks of the pod 110 are connected and a set of ports 264 that connect the pod 110 to the spine switches 90. As such, the use of the pair of switches 250, 260 provides an amount of redundancy to the pod 110. For example, if either of the switches 250, 260 fails, the nodes in the pod 110 may still maintain data communication with the remainder of the data center 100 (e.g., nodes of other pods) through the other switch 250, 260. Furthermore, in the illustrative embodiment, the switches 90, 250, 260 may be embodied as dual-mode optical switches, capable of routing both Ethernet protocol communications carrying Internet Protocol (IP) packets and communications according to a second, high-performance link-layer protocol (e.g., PCI Express or Compute Express Link) via optical signaling media of an optical fabric.

It should be appreciated that each of the other pods 70, 130, 80 (as well as any additional pods of the data center 100) may be similarly structured as, and have components similar to, the pod 110 shown in and described in regard to FIG. 2 (e.g., each pod may have rows of racks housing multiple nodes as described above). Additionally, while two pod switches 250, 260 are shown, it should be understood that in other embodiments, each pod 110, 70, 130, 80 may be connected to a different number of pod switches, providing even more failover capacity. Of course, in other embodiments, pods may be arranged differently than the rows-of-racks configuration shown in FIGS. 1-2. For example, a pod may be embodied as multiple sets of racks in which each set of racks is arranged radially, e.g., the racks are equidistant from a center switch.

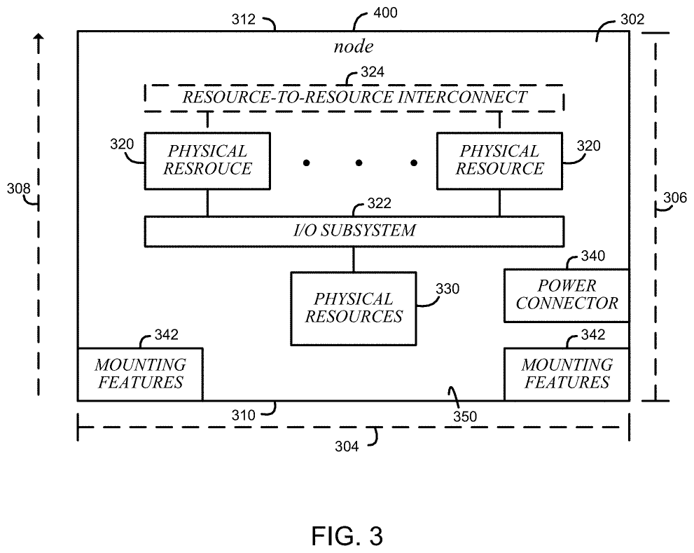

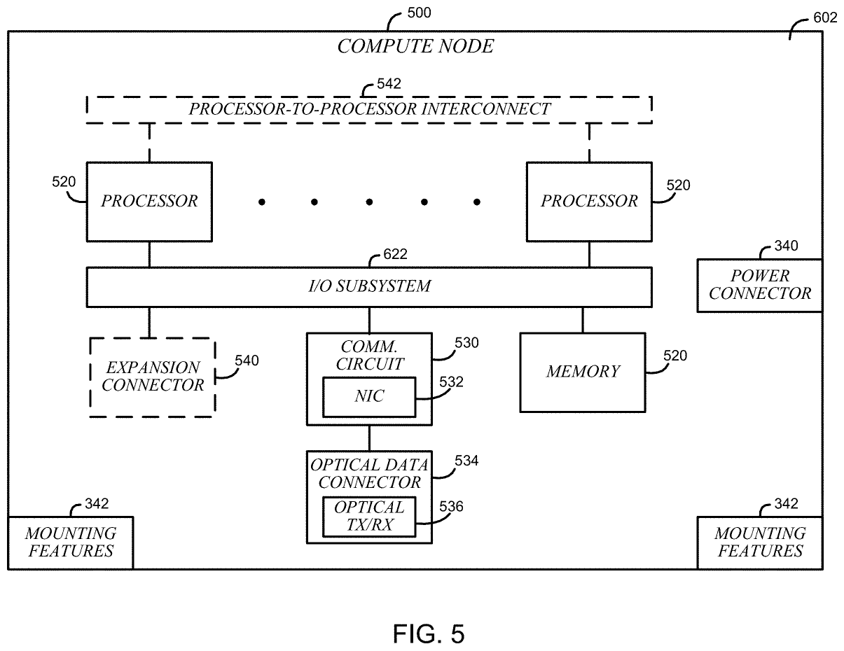

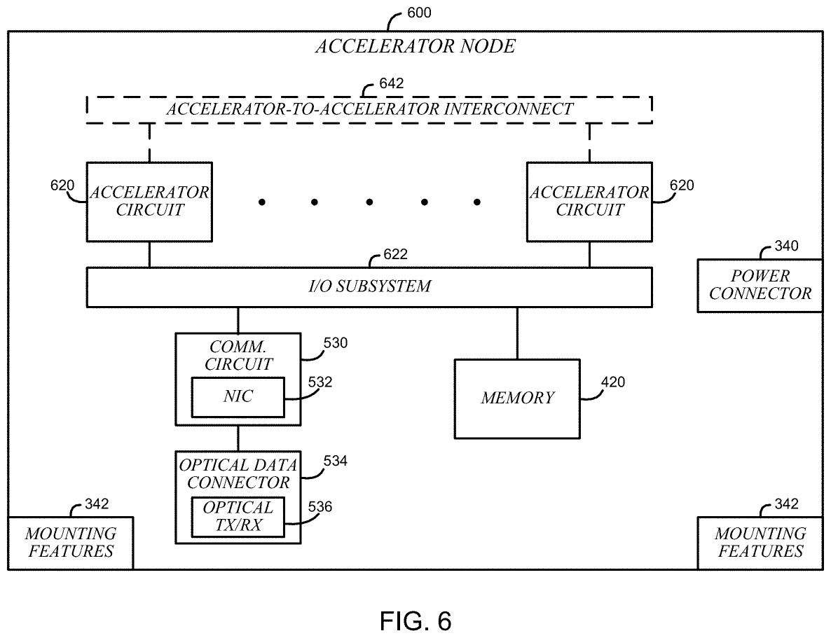

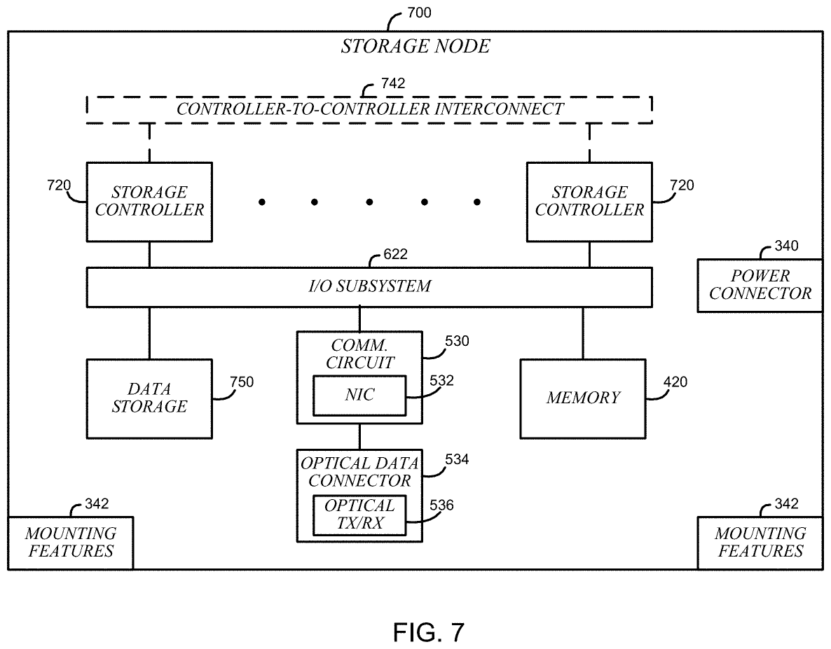

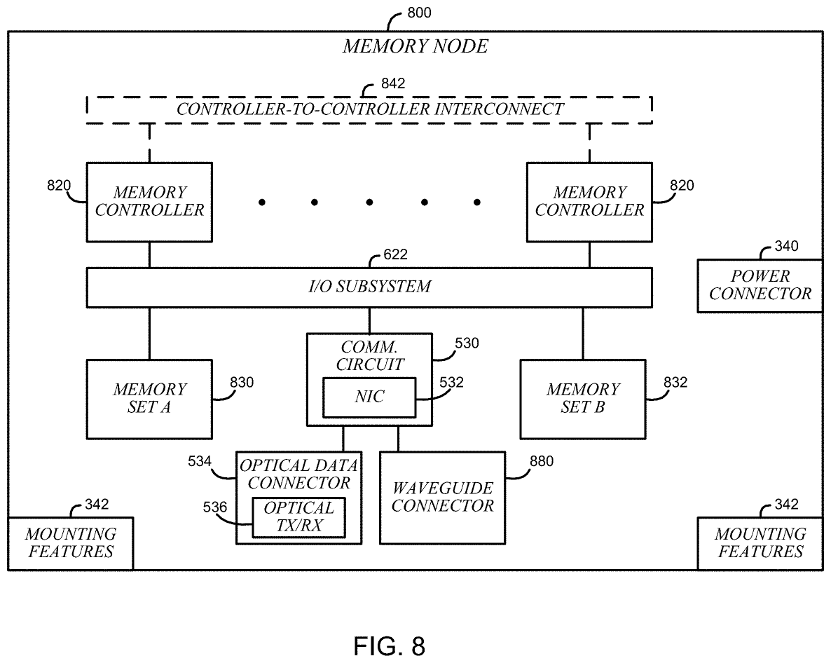

Referring now to FIG. 3, node 400, in the illustrative embodiment, is configured to be mounted in a corresponding rack 240 of the data center 100 as discussed above. In some embodiments, each node 400 may be optimized or otherwise configured for performing particular tasks, such as compute tasks, acceleration tasks, data storage tasks, etc. For example, the node 400 may be embodied as a compute node 500 as discussed below in regard to FIG. 5, an accelerator node 600 as discussed below in regard to FIG. 6, a storage node 700 as discussed below in regard to FIG. 7, or as a node optimized or otherwise configured to perform other specialized tasks, such as a memory node 800, discussed below in regard to FIG. 8.

As discussed above, the illustrative node 400 includes a circuit board substrate 302, which supports various physical resources (e.g., electrical components) mounted thereon.

As discussed above, the illustrative node 400 includes one or more physical resources 320 mounted to a top side 350 of the circuit board substrate 302. Although two physical resources 320 are shown in FIG. 3, it should be appreciated that the node 400 may include one, two, or more physical resources 320 in other embodiments. The physical resources 320 may be embodied as any type of processor, controller, or other compute circuit capable of performing various tasks such as compute functions and/or controlling the functions of the node 400 depending on, for example, the type or intended functionality of the node 400. For example, as discussed in more detail below, the physical resources 320 may be embodied as high-performance processors in embodiments in which the node 400 is embodied as a compute node, as accelerator co-processors or circuits in embodiments in which the node 400 is embodied as an accelerator node, storage controllers in embodiments in which the node 400 is embodied as a storage node, or a set of memory devices in embodiments in which the node 400 is embodied as a memory node.

The node 400 also includes one or more additional physical resources 330 mounted to the top side 350 of the circuit board substrate 302. In the illustrative embodiment, the additional physical resources include a network interface controller (NIC) as discussed in more detail below. Of course, depending on the type and functionality of the node 400, the physical resources 330 may include additional or other electrical components, circuits, and/or devices in other embodiments.

The physical resources 320 can be communicatively coupled to the physical resources 330 via an input/output (I/O) subsystem 322. The I/O subsystem 322 may be embodied as circuitry and/or components to facilitate input/output operations with the physical resources 320, the physical resources 330, and/or other components of the node 400. For example, the I/O subsystem 322 may be embodied as, or otherwise include, memory controller hubs, input/output control hubs, integrated sensor hubs, firmware devices, communication links (e.g., point-to-point links, bus links, wires, cables, waveguides, light guides, printed circuit board traces, etc.), and/or other components and subsystems to facilitate the input/output operations. In the illustrative embodiment, the I/O subsystem 322 is embodied as, or otherwise includes, a double data rate 4 (DDR4) data bus or a DDR5 data bus.

In some embodiments, the node 400 may also include a resource-to-resource interconnect 324. The resource-to-resource interconnect 324 may be embodied as any type of communication interconnect capable of facilitating resource-to-resource communications. In the illustrative embodiment, the resource-to-resource interconnect 324 is embodied as a high-speed point-to-point interconnect (e.g., faster than the I/O subsystem 322). For example, the resource-to-resource interconnect 324 may be embodied as a QuickPath Interconnect (QPI), an UltraPath Interconnect (UPI), PCI express (PCIe), or other high-speed point-to-point interconnect dedicated to resource-to-resource communications.

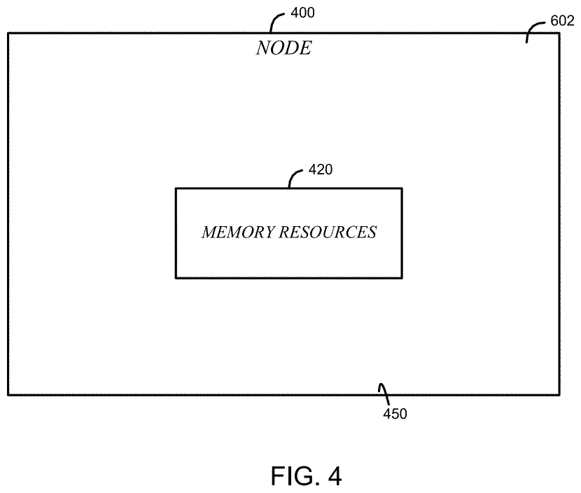

The node 400 also includes a power connector 340 configured to mate with a corresponding power connector of the rack 240 when the node 400 is mounted in the corresponding rack 240. The node 400 receives power from a power supply of the rack 240 via the power connector 340 to supply power to the various electrical components of the node 400. That is, the node 400 does not include any local power supply (e.g., an on-board power supply) to provide power to the electrical components of the node 400. The exclusion of a local or on-board power supply facilitates the reduction in the overall footprint of the circuit board substrate 302, which may increase the thermal cooling characteristics of the various electrical components mounted on the circuit board substrate 302 as discussed above. In some embodiments, voltage regulators are placed on a bottom side 450 (see FIG. 4) of the circuit board substrate 302 directly opposite of the processors 520 (see FIG. 5), and power is routed from the voltage regulators to the processors 520 by vias extending through the circuit board substrate 302. Such a configuration provides an increased thermal budget, additional current and/or voltage, and better voltage control relative to typical printed circuit boards in which processor power is delivered from a voltage regulator, in part, by printed circuit traces.

In some embodiments, the node 400 may also include mounting features 342 configured to mate with a mounting arm, or other structure, of a robot to facilitate the placement of the node 300 in a rack 240 by the robot. The mounting features 342 may be embodied as any type of physical structures that allow the robot to grasp the node 400 without damaging the circuit board substrate 302 or the electrical components mounted thereto. For example, in some embodiments, the mounting features 342 may be embodied as non-conductive pads attached to the circuit board substrate 302. In other embodiments, the mounting features may be embodied as brackets, braces, or other similar structures attached to the circuit board substrate 302. The particular number, shape, size, and/or make-up of the mounting feature 342 may depend on the design of the robot configured to manage the node 400.

Referring now to FIG. 4, in addition to the physical resources 330 mounted on the top side 350 of the circuit board substrate 302, the node 400 also includes one or more memory devices 420 mounted to a bottom side 450 of the circuit board substrate 302. That is, the circuit board substrate 302 can be embodied as a double-sided circuit board. The physical resources 320 can be communicatively coupled to memory devices 420 via the I/O subsystem 322. For example, the physical resources 320 and the memory devices 420 may be communicatively coupled by one or more vias extending through the circuit board substrate 302. A physical resource 320 may be communicatively coupled to a different set of one or more memory devices 420 in some embodiments. Alternatively, in other embodiments, each physical resource 320 may be communicatively coupled to each memory device 420.

The memory devices 420 may be embodied as any type of memory device capable of storing data for the physical resources 320 during operation of the node 400, such as any type of volatile (e.g., dynamic random access memory (DRAM), etc.) or non-volatile memory. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A block can be any size such as but not limited to 2 KB, 4 KB, 5 KB, and so forth. A memory device may also include next-generation nonvolatile devices, such as Intel Optane® memory or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In some embodiments, the memory device may comprise a transistor-less stackable cross point architecture in which memory cells sit at the intersection of word lines and bit lines and are individually addressable and in which bit storage is based on a change in bulk resistance.

Referring now to FIG. 5, in some embodiments, the node 400 may be embodied as a compute node 500. The compute node 500 can be configured to perform compute tasks. Of course, as discussed above, the compute node 500 may rely on other nodes, such as acceleration nodes and/or storage nodes, to perform compute tasks.

In the illustrative compute node 500, the physical resources 320 are embodied as processors 520. Although only two processors 520 are shown in FIG. 5, it should be appreciated that the compute node 500 may include additional processors 520 in other embodiments. Illustratively, the processors 520 are embodied as high-performance processors 520 and may be configured to operate at a relatively high power rating.

In some embodiments, the compute node 500 may also include a processor-to-processor interconnect 542. Processor-to-processor interconnect 542 may be embodied as any type of communication interconnect capable of facilitating processor-to-processor interconnect 542 communications. In the illustrative embodiment, the processor-to-processor interconnect 542 is embodied as a high-speed point-to-point interconnect (e.g., faster than the I/O subsystem 322). For example, the processor-to-processor interconnect 542 may be embodied as a QuickPath Interconnect (QPI), an UltraPath Interconnect (UPI), or other high-speed point-to-point interconnect dedicated to processor-to-processor communications (e.g., PCIe or CXL).

The compute node 500 also includes a communication circuit 530. The illustrative communication circuit 530 includes a network interface controller (NIC) 532, which may also be referred to as a host fabric interface (HFI). The NIC 532 may be embodied as, or otherwise include, any type of integrated circuit, discrete circuits, controller chips, chipsets, add-in-boards, daughtercards, network interface cards, or other devices that may be used by the compute node 500 to connect with another compute device (e.g., with other nodes 400). In some embodiments, the NIC 532 may be embodied as part of a system-on-a-chip (SoC) that includes one or more processors, or included on a multichip package that also contains one or more processors. In some embodiments, the NIC 532 may include a local processor (not shown) and/or a local memory (not shown) that are both local to the NIC 532. In such embodiments, the local processor of the NIC 532 may be capable of performing one or more of the functions of the processors 520. Additionally or alternatively, in such embodiments, the local memory of the NIC 532 may be integrated into one or more components of the compute node at the board level, socket level, chip level, and/or other levels. In some examples, a network interface includes a network interface controller or a network interface card. In some examples, a network interface can include one or more of a network interface controller (NIC) 532, a host fabric interface (HFI), a host bus adapter (HBA), network interface connected to a bus or connection (e.g., PCIe, CXL, DDR, and so forth). In some examples, a network interface can be part of a switch or a system-on-chip (SoC).

The communication circuit 530 is communicatively coupled to an optical data connector 534. The optical data connector 534 is configured to mate with a corresponding optical data connector of a rack when the compute node 500 is mounted in the rack. Illustratively, the optical data connector 534 includes a plurality of optical fibers which lead from a mating surface of the optical data connector 534 to an optical transceiver 536. The optical transceiver 536 is configured to convert incoming optical signals from the rack-side optical data connector to electrical signals and to convert electrical signals to outgoing optical signals to the rack-side optical data connector. Although shown as forming part of the optical data connector 534 in the illustrative embodiment, the optical transceiver 536 may form a portion of the communication circuit 530 in other embodiments.

In some embodiments, the compute node 500 may also include an expansion connector 540. In such embodiments, the expansion connector 540 is configured to mate with a corresponding connector of an expansion circuit board substrate to provide additional physical resources to the compute node 500. The additional physical resources may be used, for example, by the processors 520 during operation of the compute node 500. The expansion circuit board substrate may be substantially similar to the circuit board substrate 302 discussed above and may include various electrical components mounted thereto. The particular electrical components mounted to the expansion circuit board substrate may depend on the intended functionality of the expansion circuit board substrate. For example, the expansion circuit board substrate may provide additional compute resources, memory resources, and/or storage resources. As such, the additional physical resources of the expansion circuit board substrate may include, but is not limited to, processors, memory devices, storage devices, and/or accelerator circuits including, for example, field programmable gate arrays (FPGA), application-specific integrated circuits (ASICs), security co-processors, graphics processing units (GPUs), machine learning circuits, or other specialized processors, controllers, devices, and/or circuits.

Referring now to FIG. 6, in some embodiments, the node 400 may be embodied as an accelerator node 600. The accelerator node 600 is configured to perform specialized compute tasks, such as machine learning, encryption, hashing, or other computational-intensive task. In some embodiments, for example, a compute node 500 may offload tasks to the accelerator node 600 during operation. The accelerator node 600 includes various components similar to components of the node 400 and/or compute node 500, which have been identified in FIG. 6 using the same reference numbers.

In the illustrative accelerator node 600, the physical resources 320 are embodied as accelerator circuits 620. Although only two accelerator circuits 620 are shown in FIG. 6, it should be appreciated that the accelerator node 600 may include additional accelerator circuits 620 in other embodiments. The accelerator circuits 620 may be embodied as any type of processor, co-processor, compute circuit, or other device capable of performing compute or processing operations. For example, the accelerator circuits 620 may be embodied as, for example, central processing units, cores, field programmable gate arrays (FPGA), application-specific integrated circuits (ASICs), programmable control logic (PCL), security co-processors, graphics processing units (GPUs), neuromorphic processor units, quantum computers, machine learning circuits, or other specialized processors, controllers, devices, and/or circuits.

In some embodiments, the accelerator node 600 may also include an accelerator-to-accelerator interconnect 642. Similar to the resource-to-resource interconnect 324 of the node 300 discussed above, the accelerator-to-accelerator interconnect 642 may be embodied as any type of communication interconnect capable of facilitating accelerator-to-accelerator communications. In the illustrative embodiment, the accelerator-to-accelerator interconnect 642 is embodied as a high-speed point-to-point interconnect (e.g., faster than the I/O subsystem 322). For example, the accelerator-to-accelerator interconnect 642 may be embodied as a QuickPath Interconnect (QPI), an UltraPath Interconnect (UPI), or other high-speed point-to-point interconnect dedicated to processor-to-processor communications. In some embodiments, the accelerator circuits 620 may be daisy-chained with a primary accelerator circuit 620 connected to the NIC 532 and memory 420 through the I/O subsystem 322 and a secondary accelerator circuit 620 connected to the NIC 532 and memory 420 through a primary accelerator circuit 620.

Referring now to FIG. 7, in some embodiments, the node 400 may be embodied as a storage node 700. The storage node 700 is configured, to store data in a data storage 750 local to the storage node 700. For example, during operation, a compute node 500 or an accelerator node 600 may store and retrieve data from the data storage 750 of the storage node 700. The storage node 700 includes various components similar to components of the node 400 and/or the compute node 500, which have been identified in FIG. 7 using the same reference numbers.

In the illustrative storage node 700, the physical resources 320 are embodied as storage controllers 720. Although only two storage controllers 720 are shown in FIG. 7, it should be appreciated that the storage node 700 may include additional storage controllers 720 in other embodiments. The storage controllers 720 may be embodied as any type of processor, controller, or control circuit capable of controlling the storage and retrieval of data into the data storage 750 based on requests received via the communication circuit 530. In the illustrative embodiment, the storage controllers 720 are embodied as relatively low-power processors or controllers.

In some embodiments, the storage node 700 may also include a controller-to-controller interconnect 742. Similar to the resource-to-resource interconnect 324 of the node 400 discussed above, the controller-to-controller interconnect 742 may be embodied as any type of communication interconnect capable of facilitating controller-to-controller communications. In the illustrative embodiment, the controller-to-controller interconnect 742 is embodied as a high-speed point-to-point interconnect (e.g., faster than the I/O subsystem 322). For example, the controller-to-controller interconnect 742 may be embodied as a QuickPath Interconnect (QPI), an UltraPath Interconnect (UPI), or other high-speed point-to-point interconnect dedicated to processor-to-processor communications.

Referring now to FIG. 8, in some embodiments, the node 400 may be embodied as a memory node 800. The memory node 800 is configured to provide other nodes 400 (e.g., compute nodes 500, accelerator nodes 600, etc.) with access to a pool of memory (e.g., in two or more sets 830, 832 of memory devices 420) local to the storage node 700. For example, during operation, a compute node 500 or an accelerator node 600 may remotely write to and/or read from one or more of the memory sets 830, 832 of the memory node 800 using a logical address space that maps to physical addresses in the memory sets 830, 832.

In the illustrative memory node 800, the physical resources 320 are embodied as memory controllers 820. Although only two memory controllers 820 are shown in FIG. 8, it should be appreciated that the memory node 800 may include additional memory controllers 820 in other embodiments. The memory controllers 820 may be embodied as any type of processor, controller, or control circuit capable of controlling the writing and reading of data into the memory sets 830, 832 based on requests received via the communication circuit 530. In the illustrative embodiment, each memory controller 820 is connected to a corresponding memory set 830, 832 to write to and read from memory devices 420 within the corresponding memory set 830, 832 and enforce any permissions (e.g., read, write, etc.) associated with node 400 that has sent a request to the memory node 800 to perform a memory access operation (e.g., read or write).

In some embodiments, the memory node 800 may also include a controller-to-controller interconnect 842. Similar to the resource-to-resource interconnect 324 of the node 400 discussed above, the controller-to-controller interconnect 842 may be embodied as any type of communication interconnect capable of facilitating controller-to-controller communications. In the illustrative embodiment, the controller-to-controller interconnect 842 is embodied as a high-speed point-to-point interconnect (e.g., faster than the I/O subsystem 322). For example, the controller-to-controller interconnect 842 may be embodied as a QuickPath Interconnect (QPI), an UltraPath Interconnect (UPI), or other high-speed point-to-point interconnect dedicated to processor-to-processor communications. As such, in some embodiments, a memory controller 820 may access, through the controller-to-controller interconnect 842, memory that is within the memory set 832 associated with another memory controller 820. In some embodiments, a scalable memory controller is made of multiple smaller memory controllers, referred to herein as “chiplets”, on a memory node (e.g., the memory node 800). The chiplets may be interconnected (e.g., using EMIB (Embedded Multi-Die Interconnect Bridge)). The combined chiplet memory controller may scale up to a relatively large number of memory controllers and I/O ports, (e.g., up to 16 memory channels). In some embodiments, the memory controllers 820 may implement a memory interleave (e.g., one memory address is mapped to the memory set 830, the next memory address is mapped to the memory set 832, and the third address is mapped to the memory set 830, etc.). The interleaving may be managed within the memory controllers 820, or from CPU sockets (e.g., of the compute node 500) across network links to the memory sets 830, 832, and may improve the latency associated with performing memory access operations as compared to accessing contiguous memory addresses from the same memory device.

Further, in some embodiments, the memory node 800 may be connected to one or more other nodes 400 (e.g., in the same rack 240 or an adjacent rack 240) through a waveguide, using the waveguide connector 880. In the illustrative embodiment, the waveguides are 64 millimeter waveguides that provide 16 Rx (e.g., receive) lanes and 16 Tx (e.g., transmit) lanes. Each lane, in the illustrative embodiment, is either 16 GHz or 32 GHz. In other embodiments, the frequencies may be different. Using a waveguide may provide high throughput access to the memory pool (e.g., the memory sets 830, 832) to another node (e.g., a node 400 in the same rack 240 or an adjacent rack 240 as the memory node 800) without adding to the load on the optical data connector 534.

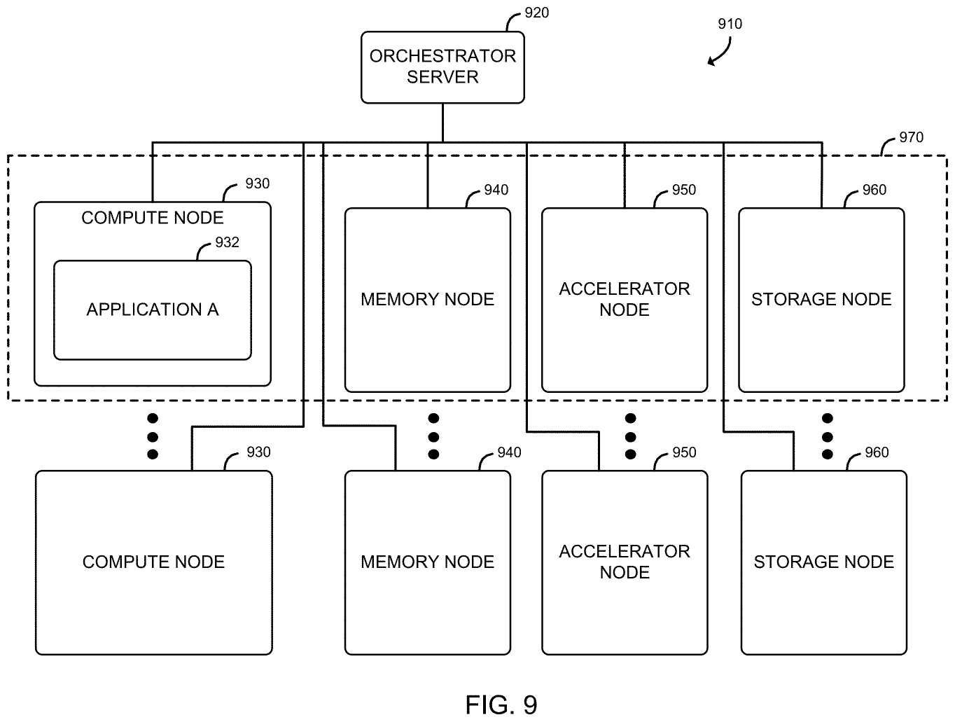

Referring now to FIG. 9, a system for executing one or more workloads (e.g., applications) may be implemented. In the illustrative embodiment, the system 910 includes an orchestrator server 920, which may be embodied as a managed node comprising a compute device (e.g., a processor 520 on a compute node 500) executing management software (e.g., a cloud operating environment, such as OpenStack) that is communicatively coupled to multiple nodes 400 including a large number of compute nodes 930 (e.g., each similar to the compute node 500), memory nodes 940 (e.g., each similar to the memory node 800), accelerator nodes 950 (e.g., each similar to the memory node 600), and storage nodes 960 (e.g., each similar to the storage node 700). One or more of the nodes 930, 940, 950, 960 may be grouped into a managed node 970, such as by the orchestrator server 920, to collectively perform a workload (e.g., an application 932 executed in a virtual machine or in a container).

The managed node 970 may be embodied as an assembly of physical resources 320, such as processors 520, memory resources 420, accelerator circuits 620, or data storage 750, from the same or different nodes 400. Further, the managed node may be established, defined, or “spun up” by the orchestrator server 920 at the time a workload is to be assigned to the managed node or at any other time, and may exist regardless of whether any workloads are presently assigned to the managed node. In the illustrative embodiment, the orchestrator server 920 may selectively allocate and/or deallocate physical resources 320 from the nodes 400 and/or add or remove one or more nodes 400 from the managed node 970 as a function of quality of service (QoS) targets (e.g., a target throughput, a target latency, a target number instructions per second, etc.) associated with a service level agreement for the workload (e.g., the application 932). In doing so, the orchestrator server 920 may receive telemetry data indicative of performance conditions (e.g., throughput, latency, instructions per second, etc.) in each node 400 of the managed node 970 and compare the telemetry data to the quality of service targets to determine whether the quality of service targets are being satisfied. The orchestrator server 920 may additionally determine whether one or more physical resources may be deallocated from the managed node 970 while still satisfying the QoS targets, thereby freeing up those physical resources for use in another managed node (e.g., to execute a different workload). Alternatively, if the QoS targets are not presently satisfied, the orchestrator server 920 may determine to dynamically allocate additional physical resources to assist in the execution of the workload (e.g., the application 932) while the workload is executing. Similarly, the orchestrator server 920 may determine to dynamically deallocate physical resources from a managed node if the orchestrator server 920 determines that deallocating the physical resource would result in QoS targets still being met.

Additionally, in some embodiments, the orchestrator server 920 may identify trends in the resource utilization of the workload (e.g., the application 932), such as by identifying phases of execution (e.g., time periods in which different operations, each having different resource utilizations characteristics, are performed) of the workload (e.g., the application 932) and pre-emptively identifying available resources in the data center and allocating them to the managed node 970 (e.g., within a predefined time period of the associated phase beginning). In some embodiments, the orchestrator server 920 may model performance based on various latencies and a distribution scheme to place workloads among compute nodes and other resources (e.g., accelerator nodes, memory nodes, storage nodes) in the data center. For example, the orchestrator server 920 may utilize a model that accounts for the performance of resources on the nodes 400 (e.g., FPGA performance, memory access latency, etc.) and the performance (e.g., congestion, latency, bandwidth) of the path through the network to the resource (e.g., FPGA). As such, the orchestrator server 920 may determine which resource(s) should be used with which workloads based on the total latency associated with each potential resource available in the data center 100 (e.g., the latency associated with the performance of the resource itself in addition to the latency associated with the path through the network between the compute node executing the workload and the node 400 on which the resource is located).

In some embodiments, the orchestrator server 920 may generate a map of heat generation in the data center 100 using telemetry data (e.g., temperatures, fan speeds, etc.) reported from the nodes 400 and allocate resources to managed nodes as a function of the map of heat generation and predicted heat generation associated with different workloads, to maintain a target temperature and heat distribution in the data center 100. Additionally or alternatively, in some embodiments, the orchestrator server 920 may organize received telemetry data into a hierarchical model that is indicative of a relationship between the managed nodes (e.g., a spatial relationship such as the physical locations of the resources of the managed nodes within the data center 100 and/or a functional relationship, such as groupings of the managed nodes by the customers the managed nodes provide services for, the types of functions typically performed by the managed nodes, managed nodes that typically share or exchange workloads among each other, etc.). Based on differences in the physical locations and resources in the managed nodes, a given workload may exhibit different resource utilizations (e.g., cause a different internal temperature, use a different percentage of processor or memory capacity) across the resources of different managed nodes. The orchestrator server 920 may determine the differences based on the telemetry data stored in the hierarchical model and factor the differences into a prediction of future resource utilization of a workload if the workload is reassigned from one managed node to another managed node, to accurately balance resource utilization in the data center 100. In some embodiments, the orchestrator server 920 may identify patterns in resource utilization phases of the workloads and use the patterns to predict future resource utilization of the workloads.

To reduce the computational load on the orchestrator server 920 and the data transfer load on the network, in some embodiments, the orchestrator server 920 may send self-test information to the nodes 400 to enable each node 400 to locally (e.g., on the node 400) determine whether telemetry data generated by the node 400 satisfies one or more conditions (e.g., an available capacity that satisfies a predefined threshold, a temperature that satisfies a predefined threshold, etc.). Each node 400 may then report back a simplified result (e.g., yes or no) to the orchestrator server 920, which the orchestrator server 920 may utilize in determining the allocation of resources to managed nodes.

### Edge Network

Edge computing, at a general level, refers to the implementation, coordination, and use of computing and resources at locations closer to the “edge” or collection of “edges” of the network. The purpose of this arrangement is to improve total cost of ownership, reduce application and network latency, reduce network backhaul traffic and associated energy consumption, improve service capabilities, and improve compliance with security or data privacy requirements (especially as compared to conventional cloud computing). Components that can perform edge computing operations (“edge nodes”) can reside in whatever location needed by the system architecture or ad hoc service (e.g., in an high performance compute data center or cloud installation; a designated edge node server, an enterprise server, a roadside server, a telecom central office; or a local or peer at-the-edge device being served consuming edge services).

Applications that have been adapted for edge computing include but are not limited to virtualization of traditional network functions (e.g., to operate telecommunications or Internet services) and the introduction of next-generation features and services (e.g., to support 5G network services). Use-cases which are projected to extensively utilize edge computing include connected self-driving cars, surveillance, Internet of Things (IoT) device data analytics, video encoding and analytics, location aware services, device sensing in Smart Cities, among many other network and compute intensive services.

Edge computing may, in some scenarios, offer or host a cloud-like distributed service, to offer orchestration and management for applications and coordinated service instances among many types of storage and compute resources. Edge computing is also expected to be closely integrated with existing use cases and technology developed for IoT and Fog/distributed networking configurations, as endpoint devices, clients, and gateways attempt to access network resources and applications at locations closer to the edge of the network.

The following embodiments generally relate to data processing, service management, resource allocation, compute management, network communication, application partitioning, and communication system implementations, and in particular, to techniques and configurations for adapting various edge computing devices and entities to dynamically support multiple entities (e.g., multiple tenants, users, stakeholders, service instances, applications, etc.) in a distributed edge computing environment.

In the following description, methods, configurations, and related apparatuses are disclosed for various improvements to the configuration and functional capabilities of an edge computing architecture and an implementing edge computing system. These improvements may benefit a variety of use cases, especially those involving multiple stakeholders of the edge computing system—whether in the form of multiple users of a system, multiple tenants on a system, multiple devices or user equipment interacting with a system, multiple services being offered from a system, multiple resources being available or managed within a system, multiple forms of network access being exposed for a system, multiple locations of operation for a system, and the like. Such multi-dimensional aspects and considerations are generally referred to herein as “multi-entity” constraints, with specific discussion of resources managed or orchestrated in multi-tenant and multi-service edge computing configurations.

With the illustrative edge networking systems described below, computing and storage resources are moved closer to the edge of the network (e.g., closer to the clients, endpoint devices, or “things”). By moving the computing and storage resources closer to the device producing or using the data, various latency, compliance, and/or monetary or resource cost constraints may be achievable relative to a standard networked (e.g., cloud computing) system. To do so, in some examples, pools of compute, memory, and/or storage resources may be located in, or otherwise equipped with, local servers, routers, and/or other network equipment. Such local resources facilitate the satisfying of constraints placed on the system. For example, the local compute and storage resources allow an edge system to perform computations in real-time or near real-time, which may be a consideration in low latency user-cases such as autonomous driving, video surveillance, and mobile media consumption. Additionally, these resources will benefit from service management in an edge system which provides the ability to scale and achieve local SLAs, manage tiered service requirements, and enable local features and functions on a temporary or permanent basis.

An illustrative edge computing system may support and/or provide various services to endpoint devices (e.g., client user equipment (UEs)), each of which may have different requirements or constraints. For example, some services may have priority or quality-of-service (QoS) constraints (e.g., traffic data for autonomous vehicles may have a higher priority than temperature sensor data), reliability and resiliency (e.g., traffic data may require mission-critical reliability, while temperature data may be allowed some error variance), as well as power, cooling, and form-factor constraints. These and other technical constraints may offer significant complexity and technical challenges when applied in the multi-stakeholder setting.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud in a multi-tenant, multi-owner, or multi-access setting, where services and applications are requested by many users, especially as network usage dynamically fluctuates and the composition of the multiple stakeholders, use cases, and services changes.

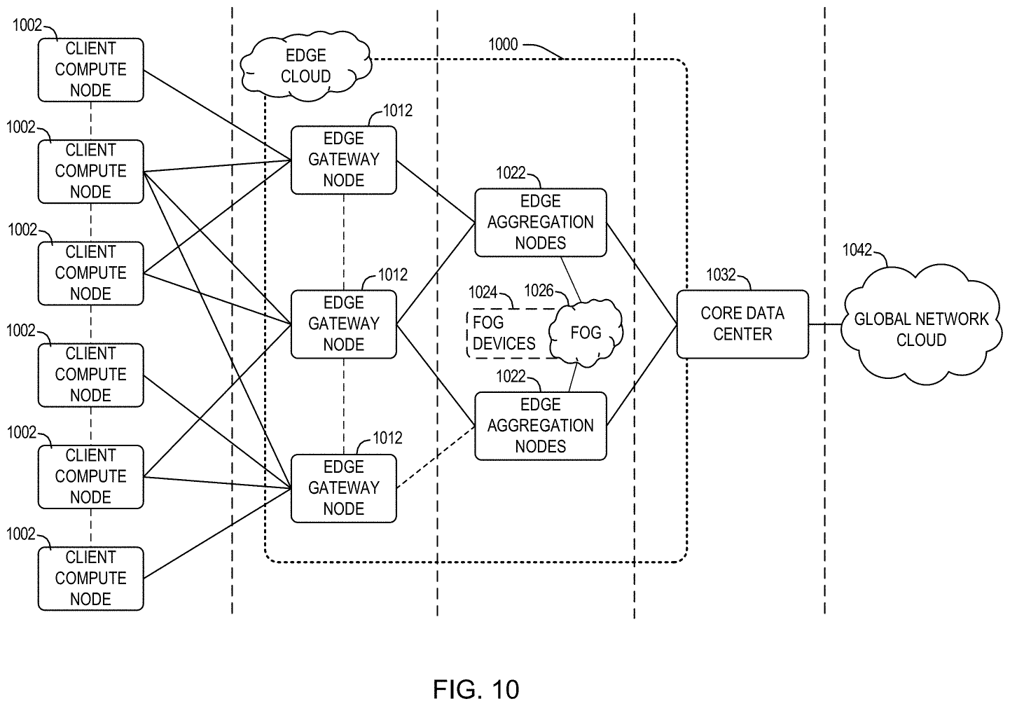

FIG. 10 generically depicts an edge computing system 1000 for providing edge services and applications to multi-stakeholder entities, as distributed among one or more client compute nodes 1002, one or more edge gateway nodes 1012, one or more edge aggregation nodes 1022, one or more core data centers 1032, and a global network cloud 1042, as distributed across layers of the network. The implementation of the edge computing system 1000 may be provided at or on behalf of a telecommunication service provider (“telco”, or “TSP”), internet-of-things service provider, cloud service provider (CSP), enterprise entity, or any other number of entities. Various implementations and configurations of the system 1000 may be provided dynamically, such as when orchestrated to meet service objectives.

For example, the client compute nodes 1002 are located at an endpoint layer, while the edge gateway nodes 1012 are located at an edge devices layer (local level) of the edge computing system 1000. Additionally, the edge aggregation nodes 1022 (and/or fog devices 1024, if arranged or operated with or among a fog networking configuration 1026) are located at a network access layer (an intermediate level). Fog computing (or “fogging”) generally refers to extensions of cloud computing to the edge of an enterprise's network or to the ability to manage transactions across the cloud/edge landscape, typically in a coordinated distributed or multi-node network. Some forms of fog computing provide the deployment of compute, storage, and networking services between end devices and cloud computing data centers, on behalf of the cloud computing locations. Some forms of fog computing also provide the ability to manage the workload/workflow level services, in terms of the overall transaction, by pushing certain workloads to the edge or to the cloud based on the ability to fulfill the overall service level agreement.

Fog computing in many scenarios provide a decentralized architecture and serves as an extension to cloud computing by collaborating with one or more edge node devices, providing the subsequent amount of localized control, configuration and management, and much more for end devices. Furthermore, Fog computing provides the ability for edge resources to identify similar resources and collaborate in order to create an edge-local cloud which can be used solely or in conjunction with cloud computing in order to complete computing, storage or connectivity related services. Fog computing may also allow the cloud-based services to expand their reach to the edge of a network of devices to offer local and quicker accessibility to edge devices. Thus, some forms of fog computing provide operations that are consistent with edge computing as discussed herein; the edge computing aspects discussed herein are also applicable to fog networks, fogging, and fog configurations. Further, aspects of the edge computing systems discussed herein may be configured as a fog, or aspects of a fog may be integrated into an edge computing architecture.

The core data center 1032 is located at a core network layer (a regional or geographically-central level), while the global network cloud 1042 is located at a cloud data center layer 240 (a national or world-wide layer). The use of “core” is provided as a term for a centralized network location—deeper in the network—which is accessible by multiple edge nodes or components; however, a “core” does not necessarily designate the “center” or the deepest location of the network. Accordingly, the core data center 1032 may be located within, at, or near the edge cloud 1000. Although an illustrative number of client compute nodes 1002, edge gateway nodes 1012, edge aggregation nodes 1022, edge core data centers 1032, global network clouds 1042 are shown in FIG. 10, it should be appreciated that the edge computing system 1000 may include additional devices or systems at each layer. Devices at any layer can be configured as peer nodes to each other and, accordingly, act in a collaborative manner to meet service objectives.

Consistent with the examples provided herein, a client compute node 1002 may be embodied as any type of endpoint component, device, appliance, or other thing capable of communicating as a producer or consumer of data. Further, the label “node” or “device” as used in the edge computing system 1000 does not necessarily mean that such node or device operates in a client or agent/minion/follower role; rather, any of the nodes or devices in the edge computing system 1000 refer to individual entities, nodes, or subsystems which include discrete or connected hardware or software configurations to facilitate or use the edge cloud 1000.

As such, the edge cloud 1000 is formed from network components and functional features operated by and within the edge gateway nodes 1012 and the edge aggregation nodes 1022. The edge cloud 1000 may be embodied as any type of network that provides edge computing and/or storage resources which are proximately located to radio access network (RAN) capable endpoint devices (e.g., mobile computing devices, IoT devices, smart devices, etc.), which are shown in FIG. 10 as the client compute nodes 1002. In other words, the edge cloud 1000 may be envisioned as an “edge” which connects the endpoint devices and traditional network access points that serves as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

In some examples, the edge cloud 1000 may form a portion of or otherwise provide an ingress point into or across a fog networking configuration 1026 (e.g., a network of fog devices 1024, not shown in detail), which may be embodied as a system-level horizontal and distributed architecture that distributes resources and services to perform a specific function. For instance, a coordinated and distributed network of fog devices 1024 may perform computing, storage, control, or networking aspects in the context of an IoT system arrangement. Other networked, aggregated, and distributed functions may exist in the edge cloud 1000 between the core data center 1032 and the client endpoints (e.g., client compute nodes 1002). Some of these are discussed in the following sections in the context of network functions or service virtualization, including the use of virtual edges and virtual services which are orchestrated for multiple stakeholders.

As discussed in more detail below, the edge gateway nodes 1012 and the edge aggregation nodes 1022 cooperate to provide various edge services and security to the client compute nodes 1002. Furthermore, because a client compute node 1002 may be stationary or mobile, a respective edge gateway node 1012 may cooperate with other edge gateway devices to propagate presently provided edge services, relevant service data, and security as the corresponding client compute node 1002 moves about a region. To do so, the edge gateway nodes 1012 and/or edge aggregation nodes 1022 may support multiple tenancy and multiple stakeholder configurations, in which services from (or hosted for) multiple service providers, owners, and multiple consumers may be supported and coordinated across a single or multiple compute devices.

A variety of security approaches may be utilized within the architecture of the edge cloud 1000. In a multi-stakeholder environment, there can be multiple loadable security modules (LSMs) used to provision policies that enforce the stakeholder's interests. Enforcement point environments could support multiple LSMs that apply the combination of loaded LSM policies (e.g., where the most constrained effective policy is applied, such as where if any of A, B or C stakeholders restricts access then access is restricted). Within the edge cloud 1000, each edge entity can provision LSMs that enforce the Edge entity interests. The Cloud entity can provision LSMs that enforce the cloud entity interests. Likewise, the various Fog and IoT network entities can provision LSMs that enforce the Fog entity's interests.

In these examples, services may be considered from the perspective of a transaction, performed against a set of contracts or ingredients, whether considered at an ingredient level or a human-perceivable level. Thus, a user who has a service agreement with a service provider, expects the service to be delivered under terms of the SLA. Although not discussed in detail, the use of the edge computing techniques discussed herein may play roles during the negotiation of the agreement and the measurement of the fulfillment of the agreement (to identify what elements are required by the system to conduct a service, how the system responds to service conditions and changes, and the like).

A “service” is a broad term often applied to various contexts, but in general it refers to a relationship between two entities where one entity offers and performs work for the benefit of another. However, the services delivered from one entity to another must be performed with certain guidelines, which ensure trust between the entities and manage the transaction according to the contract terms and conditions set forth at the beginning, during and end of the service.

The deployment of a multi-stakeholder edge computing system may be arranged and orchestrated to enable the deployment of multiple services and virtual edge instances, among multiple edge nodes and subsystems, for use by multiple tenants and service providers. In a system example applicable to a cloud service provider (CSP), the deployment of an edge computing system may be provided via an “over-the-top” approach, to introduce edge computing nodes as a supplemental tool to cloud computing. In a contrasting system example applicable to a telecommunications service provider (TSP), the deployment of an edge computing system may be provided via a “network-aggregation” approach, to introduce edge computing nodes at locations in which network accesses (from different types of data access networks) are aggregated. FIGS. 5 and 6 contrast these over-the-top and network-aggregation approaches for networking and services in respective edge computing system. However, these over-the-top and network aggregation approaches may be implemented together in a hybrid or merged approach or configuration as suggested in later examples.

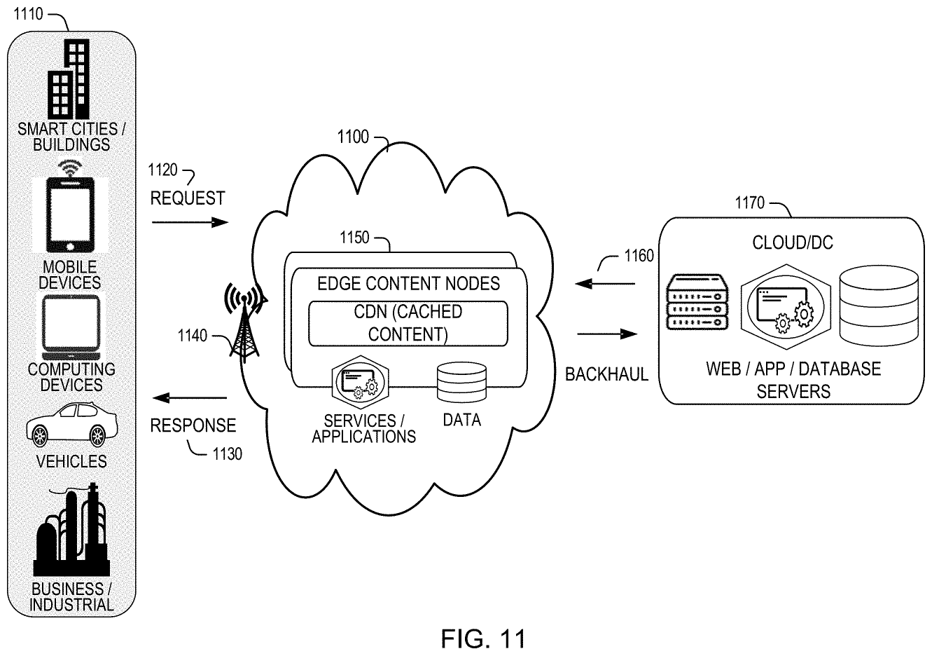

FIG. 11 shows an example where various client endpoints 1110 (in the form of mobile devices, computers, autonomous vehicles, business computing equipment, industrial processing equipment) provide requests 1120 for services or data transactions, and receive responses 1130 for the services or data transactions, to and from the edge cloud 1100 (e.g., via a wireless or wired network 1140). Within the edge cloud 1000, the CSP may deploy various compute and storage resources, such as edge content nodes 1150 to provide cached content from a distributed content delivery network. Other available compute and storage resources available on the edge content nodes 1150 may be used to execute other services and fulfill other workloads. The edge content nodes 1150 and other systems of the edge cloud 1000 are connected to a cloud or data center 1170, which uses a backhaul network 1160 to fulfill higher-latency requests from a cloud/data center for websites, applications, database servers, etc.

### Resource Manager Access

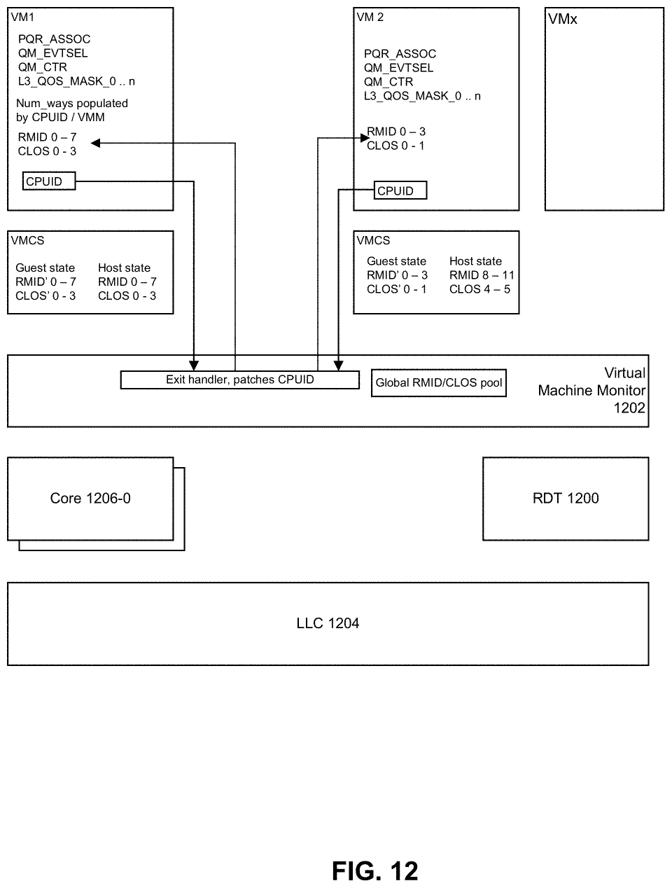

There are various applications and system software that have utilize capabilities of RDT, and these applications and system software can be deployed in virtual machines due the cloud build out and Network Functions Virtualization. FIG. 12 depicts an example of a known system that provides access to RDT to virtual machines. RDT 1200 can provide one or more of: Cache Allocation Technology (CAT), Code and Data Prioritization (CDP), Memory Bandwidth Allocation (MBA), Cache Monitoring Technology (CMT), and Memory Bandwidth Monitoring (MBM). A CPUID instruction (identified by a CPUID opcode) can include a processor supplementary instruction allowing software to discover details of the processor. Software can use the CPUID to determine processor type and whether features such as MMX/SSE are implemented. A CPUID instruction can be used to detect the presence of the architectural version of Monitoring and Allocation feature sets of RDT (e.g., CAT, CDP, MBA, CMT and MBM). For example, cpuid.(eax=07h, ecx=0h).ebx[15]==1 (at least one allocation technology supported on the processor) has been verified, then CPUID leaf 0x10 and sub-leaves provide further details on the CAT feature such as mask lengths available.

For example, CAT can provide software-guided redistribution of cache capacity, enabling important data center requesters to benefit from improved cache capacity and reduced cache contention. CAT can provide an interface for the OS or hypervisor to group requesters into classes of service (CLOS) and indicate the amount of last-level cache available to each CLOS. These interfaces can be based on MSRs (Model-Specific Registers). CAT may be used to enhance runtime determinism and prioritize important requesters such as virtual switches or Data Plane Development Kit (DPDK) packet processing apps from resource contention across various priority classes of workloads. CAT can allow an operating system (OS), hypervisor, or virtual machine manager (VMM) to control allocation of a central processing units (CPU) shared LLC.

For example, CDP can provide separate control over code and data placement in the last-level (L3) cache (e.g., LLC 1204). Certain types of workloads may benefit with increased runtime determinism, enabling greater predictability in application performance.

For example, MBA can provide control over memory bandwidth available to workloads, enabling new levels of interference mitigation and bandwidth shaping for “noisy neighbors” present on the system. Memory bandwidth can represent a rate at which data can be read from or stored into a memory device or storage device by a processor.

For example, CMT can provide monitoring of last-level cache (LLC) (e.g., LLC 1204) utilization by individual threads, applications, VMs, or containers. CMT can enable tracking of the L3 cache occupancy, enabling detailed profiling and tracking of threads, applications, or virtual machines. CMT can enables resource-aware scheduling decisions, aid in “noisy neighbor” detection and assist with performance debugging.

For example, MBM feature can support types of event reporting of local and remote memory bandwidth. Reporting local memory bandwidth can include a report of bandwidth of a thread accessing memory associated with the local socket. In a dual socket system, the remote memory bandwidth can include a report the bandwidth of a thread accessing the remote socket. For example, MBM can provide monitoring of multiple VMs, containers, or applications independently, which can provides memory bandwidth monitoring for each running thread simultaneously.

In some examples, any of VM1 to VMx (executed by one or more cores 1206-0 to 1206-y, where y is an integer) can write to or read from a set of RDT 1200-related MSRs (e.g., PQR_ASSOC, QM_EVTSEL, QM_CTR, L3_QOS MASK_0 . . . n). However, in some systems these MSRs can be programmed based on CPUID enumeration, which causes VM exit. A VM exit can mark a point at which a transition is made between the VM currently running and the VMM 1202 (e.g., hypervisor) can exercise system control to address a reason for the VM exit. In general, the processor saves a snapshot of the VM's state as it was running at the time of the exit (e.g., image capture, context save, and snapshot). VMM 1202 can determine the exit reason and determine the enumerated CPUID. VMM 1202 can review General-Purpose Registers (GPRs) (e.g., EAX and ECX) to determine which CPUID function was invoked. VMM 1202 can update EAX and GPR to report the data for the CPUID instruction. VMM 1202 can increment (in Virtual Machine Control Structure (VMCS)) guest RIP register by a length of CPUID instruction (e.g., saving length of CPUID instruction into VMCS) and perform a VMRESUME. Use of VM exit strategy on frequently used MSRs, for example PQR_ASSOC get read or write, can introduce latency, as a VM exit slows operation of a VM due at least to context saving and switching and return.

Various embodiments provide a capability for a virtualized execution environment among multiple virtualized execution environments in a server or system to request allocation by a resource manager of resources for the virtualized execution environment such as cache allocation, memory allocation, memory bandwidth (e.g., rate at which data can be read from or stored into a memory device by a virtualized execution environment), accelerator usage, processor usage, or at least other features. In some examples, a resource manager can include one or more features of Intel® Resource Director Technology (RDT). For example, a virtualized execution environment can perform cache locking (e.g., exclusive allocation of a cache (e.g., L1, L2, L3, system cache, last level cache (LLC) 1104)). A virtualized execution environment can run on one or multiple cores and its operating system (OS) can request the resource manager to allocate resources to applications or microservices within the virtualized execution environment.

Various embodiments provide hardware extensions to the Intel® Resource Director Technology (RDT) that enable a guest VEE to monitor and control shared resources (e.g., Last Level Cache, Memory Controller, memory bandwidth) without modifying the VMM, guest operating system, and/or system application software and without triggering a VM exit. Various embodiments enable ability to utilize legacy software supporting both Cloud Service Providers and Communications Service Providers.

A virtual execution environment (VEE) can include at least a virtual machine or a container. VEEs can execute in bare metal (e.g., single tenant) or hosted (e.g., multiple tenants) environments. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can be an OS or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing virtual machines to run Linux®, FreeBSD, VMWare, or Windows® Server operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers are not installed like traditional software programs, which allows them to be isolated from the other software and the operating system itself. Isolation can include permitted access of a region of addressable memory or storage by a particular container but not another container. The isolated nature of containers provides several benefits. First, the software in a container will run the same in different environments. For example, a container that includes PHP and MySQL can run identically on both a Linux computer and a Windows® machine. Second, containers provide added security since the software will not affect the host operating system. While an installed application may alter system settings and modify resources, such as the Windows® registry, a container can only modify settings within the container.

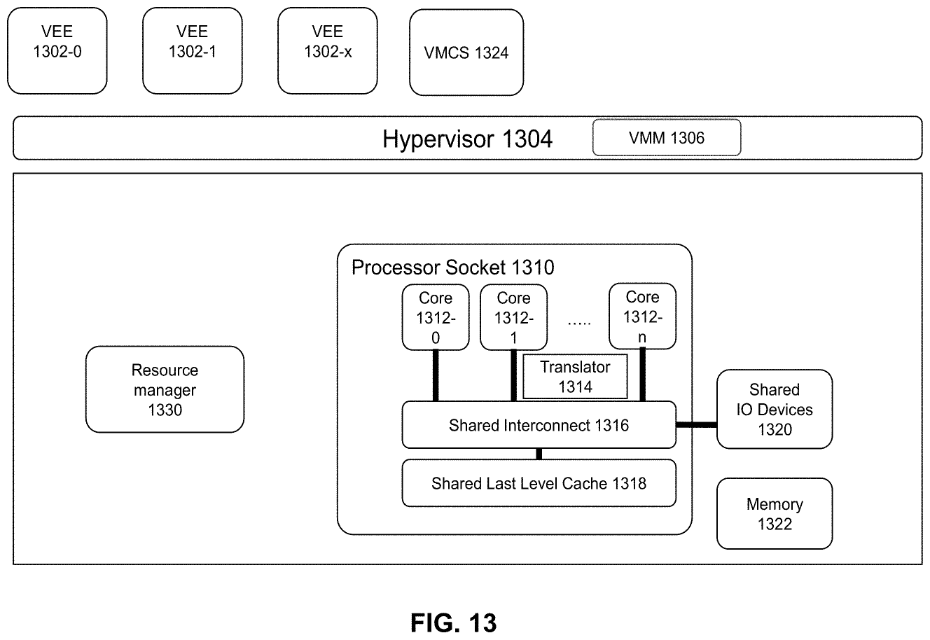

FIG. 13 depicts an example computing system. Processor socket can 1310 can include one or more cores 1312-0 to 1312-n, where n is an integer. A core can include an execution core or computational engine that is capable of executing instructions. A core can have access to its own cache and read only memory (ROM), or multiple cores can share a cache or ROM. Cores can be homogeneous and/or processor heterogeneous devices. Any type of inter-processor communication techniques can be used, such as but not limited to messaging, inter-processor interrupts (IPI), inter-processor communications, and so forth. Cores can be connected in any type of manner using shared interconnect 1316, such as, but not limited to, a bus, ring, or mesh.

Some examples of a core are part of an Infrastructure Processing Unit (IPU) or data processing unit (DPU) or utilized by an IPU or DPU. An xPU can refer at least to an IPU, DPU, GPU, GPGPU, or other processing units (e.g., accelerator). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Various examples of a processor socket 1310 can include a system agent or uncore. A system agent can include or more of a memory controller, a shared cache, a cache coherency manager, arithmetic logic units, floating point units, core or processor interconnects, or bus or link controllers. System agent can provide one or more of: direct memory access (DMA) engine connection, non-cached coherent master connection, data cache coherency between cores and arbitrates cache requests, or Advanced Microcontroller Bus Architecture (AMBA) capabilities.

Shared interconnect 1316 can provide communications among one or more cores 1312-0 to 1312-n using any topology or protocol. For example, shared interconnect 1316 can be compatible at least with Intel QuickPath Interconnect (QPI), Intel Ultra Path Interconnect (UPI), Intel On-Chip System Fabric (IOSF), Omnipath, Ethernet, Compute Express Link (CXL), HyperTransport, high-speed fabric, PCIe, NVLink, Advanced Microcontroller Bus Architecture (AMBA) interconnect, OpenCAPI, Gen-Z, CCIX, Infinity Fabric (IF), and so forth. Although not shown, CPUs, cache devices, accelerators, network interfaces, and/or other devices may be connected to shared interconnect 1316. Other devices may include, for example, shared LLC 1318, one or more memory devices (e.g., memory 1322), and shared IO devices 1320.

One or more cores 1312-0 to 1312-n can execute one or more of VEE 1302-0 to 1302-x. An application can execute within any VEE. For example, any application can include or be implemented as a service, one or more microservices, cloud native microservice, workload, or any software. Any application can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtual execution environments (e.g., VMs or containers). VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

Packet processing workloads can have stringent latency requirements. Packet data or information related to processing packets can be mapped to physical addresses that are mapped into a set in a cache. But data in the cache can be evicted which can lead to a long tail in response time. A deterministic latency for data in cache is preferred in some cases. Deterministic latency can refer to latency from accessing data from a cache, rather than from memory, and writing data to the cache (which introduces further latency). Cache quality of service (e.g., cache reservation) can help provide deterministic latency.

Situations can arise where software-implemented operations require rapid access to data or instruction code, such data or instruction code can be stored in a cache. Accordingly, the use of a cache to store data is common in highly latency sensitive scenarios such as software defined network functions virtualization (NFV) operations, broadband remote access servers (BRAS), voice over IP (VoIP), 4G or 5G switching and routing, process execution at edge nodes, command of self-driving vehicles, content distribution networks (CDN), and others. Cache resources are limited such that processors and processor-executed software contend for precious cache resources and can cause eviction of data or code from the cache. Eviction of data or code from the cache can lead to non-deterministic execution times, which may lead to violation of applicable service level agreements (SLAs) or SLOs.

Various embodiments can provide access to resource manager 1330 to any VEE to allocate resources for use by the VEE. Resource manager 1330 can be implemented as a microcontroller, state machine, core that executes a process, fixed function device (e.g., field programmable gate array), and so forth. Resource manager can provide system administrators and developers with the ability to monitor and control shared resources. In some examples, resource manager can include any technology or feature of Intel® Resource Director Technology (RDT). Resource manager 1330 can provide one or more of: Cache Allocation Technology (CAT), Code and Data Prioritization (CDP), Memory Bandwidth Allocation (MBA), Cache Monitoring Technology (CMT), and Memory Bandwidth Monitoring (MBM). Resource manager 1330 can provide platform quality of service to attempt to provide deterministic performance. In some examples, resource manager 1330 can provide a hardware framework to manage shared resource such as L3 cache, memory allocation, memory bandwidth allocation, network bandwidth, IPU, compute resources, XPU, or any hardware or software resource described herein.

Resource Monitoring IDs (RMIDs) and class of services (CLOSs) can be utilized by resource manager 1330 to allocate resources to VEEs or applications executing therein. An RMID can refer to an identifier of a VEE or application that runs on a processor. A CLOS can refer to a class of service or priority level and allocate one or more computing or device resources (e.g., hardware, firmware, and/or processor-executed software). VMM 1306 can perform CPUID enumeration by gathering a global pool of RMIDs and CLOSs available for allocation to VEEs or applications from resource manage 1330. According to some embodiments, hypervisor 1304 can allocate VMM 1306 with a pool of multiple RMIDs and CLOSs available on the platform.

A Virtual Machine Control Structure (VMCS) 1324 can include processor register states of guest VEEs and the host system. According to various embodiments, access to VMCS 1324 can allow a VEE to discover features available from resource manager 1330 and platform resources. VMCS 1324 can include a pool of RMIDs and CLOS available for allocation to a VEE (or its application). VMM 1306 can balance resources among VEEs and allocate RMID and CLOS tags to VEEs. In some examples, VMM 1306 can prevent overallocation of resources to any VEE or application. For example, based on a VM priority or orchestration template, VEEs can be allocated limited CLOS and RMID values. For example, a first VEE can subscribe to only two CLOSs and four RMIDs whereas a higher priority second VEE can utilize four CLOSs and eight RMIDs.

In some examples, a number of RMID and CLOS and range of RMID and CLOS values can be allocated to multiple VEEs based on policies applied to the VEEs (e.g., Isolate, Oversubscribe or combination of Isolate and Oversubscribe). In some examples, certain MSRs can be used to program resource manager 1330. According to some embodiments, a VEE can access these MSRs in order to monitor and allocate resources without invoking or causing VM exit but yet be subjected to restriction on resource allocation. A VEE can provide a RMID and CLOS to program MSRs related to resource manager 1330. In some examples, MSRs can be allocated per core. In some examples, MSRs can be allocated per group of two or more cores.

Contents of VMCS 1324 can be used to perform RMID and CLOS spoofing (e.g., determination if a VEE requests resource allocation using non-permitted RMID or CLOS) and provide per VEE based CPUID instruction enumeration. VMCS 1324 can provide remapping table for virtual to real resource mapping. A mapping could be implemented through scratch pad region of memory in some examples.

In order to monitor and allocate VEE writes and reads through MSRs, translator 1314 can be used. In some examples, translator 1314 can be implemented as processor-executed microcode, hardware circuitry, or FPGA. In some examples, translator 1314 can be implemented as look-up tables, hardware implementations, programmable logic arrays (PLAs), microcode read only memories (ROMs), etc.

Translator 1314 can refer to Shared Resource Allocation Table (SRAT) entries to remap VEE-provided RMID and CLOS corresponding to the particular VEE performing rdmsr or wrmsr to real RMID and CLOS values. In some examples, translator 1314 can perform MSR read and write operations in non-root mode by indexing into an SRAT table (not shown). In some examples, SRAT can be stored in privileged or memory of a processor that is not accessible except to limited devices or processes such as translator 1314 or VMM 1306. In some examples, translator 1314 can access SRAT fields for remapping the virtual RMID to real RMID values and remapping virtual CLOS to real CLOS values. SRAT can track CLOS values and RMID values allocated to a VEE. In some examples, VMCS 1324 can be used to update SRAT fields to manage or keep track of RMID and CLOS distribution per VEE to map virtual RMID and CLOS to real RMID and CLOS. If a VEE-provided RMID and CLOS correspond to permitted values allocated to the VEE, translator 1314 can write the remapped RMID and CLOS values to the MSR(s) for resource manager 1330. In other words, if the read or write are allowed or remapped to bounds that are within permitted bounds, the read or write can be passed through to MSRs. In some examples, SRAT can be updated if a VEE is created or terminated or if a VMCS is modified. A VEE write to MSRs can change content of VMCS. If the read or write are not allowed, the VMM can be invoked to indicate a fault or a general protection (GP) fault can be issued.

For example, a guest VEE can request writing of any of RMID 0 and 1 and CLOS 0 and 1, and translator 1314 can map or remap the RMID and CLOS to global RMID 100 and 101 and CLOS 10 and 11. A request to write to MSRs can fail if the request from a VEE is outside of RMID 0 and 1 and CLOS 0 and 1.

Accordingly, a VEE can access and manage features available by resource manager 1330 independent from VMM 1306 causing a VM exit. A VEE can access and manage information from VMCS 1324 using virtualization extensions that map allowable contents of VMCS 1324 to VEE's domain, but if VEE accesses information outside of bounds, then the resource allocation is not permitted and a fault may be issued.

In some examples, resource manager 1330 or any device resource allocatable using resource manager 1330 can be used accessed using single root input/output virtualization (SR-IOV) or Scalable I/O Virtualization (SIOV). SR-IOV is compatible at least with specifications available from Peripheral Component Interconnect Special Interest Group (PCI SIG) including specifications such as Single Root I/O Virtualization and Sharing specification Revision 1.1 (2010) and variations thereof and updates thereto. SR-IOV is a specification that allows a single physical PCI Express (PCIe) resource to be shared among virtual machines (VMs) using a single PCI Express hardware interface.

SIOV provides for scalable sharing of I/O devices, such as network controllers, storage controllers, graphics processing units, and other hardware accelerators across a large number of containers or virtual machines. A SIOV capable device can be configured to group its resources into multiple isolated Assignable Device Interfaces (ADIs). Direct Memory Access (DMA) transfers from/to each ADI are tagged with a unique Process Address Space identifier (PASID) number. Unlike the coarse-grained device partitioning approach of SR-IOV to create multiple VFs on a PF, SIOV enables software to flexibly compose virtual devices utilizing the hardware-assists for device sharing at finer granularity. Performance critical operations on the composed virtual device can be mapped directly to the underlying device hardware, while non-critical operations can be emulated through device-specific composition software in the host. A technical specification for SIOV is Intel® Scalable I/O Virtualization Technical Specification, revision 1.0, June 2018.

In some examples, hypervisor 1304 can perform orchestration (e.g., OpenStack or Kubernetes), whereby applications or microservices can describe their hardware requirements, and hardware platforms can describe their capabilities and the orchestration can match-make between VNFs and platforms.

Table 1 shows an example of policies available for use by VEEs that a VEE can subscribe to. For example Table 1 can be representative of a SRAT. Examples of policies include Isolate, Oversubscribe or combination of Isolate and Oversubscribe.

TABLE 1
Shared Resource Allocation Table

| | | HOST | | GUEST | | | |
|---|---|---|---|---|---|---|---|
| Index# | POLICY | RMID | CLOS | RMID | CLOS | Features | VEE# |
| 1 | ISOLATE | 0 | 0 | N/A | N/A | ALL | N/A |
| 2 | ISOLATE | 1, 2 | 1 | 0, 1 | 0 | CMT, CAT | 1 |
| 3 | OVERSUBSCRIBE | 3, 4, 5, 6 | 2, 3 | 0, 1, 2, 3 | 0, 1 | CMT, CAT, CDP | 2 |
| 5 | OVERSUBSCRIBE | 3, 4 | 2 | 0, 1 | 0 | CMT, CAT, MBM | 3 |
| 6 | COMBINATION | 5, 6 | 4 | 0, 1 | 0 | CAT, CMT, MBM, | 4 |
| | | | | | | MBA | |

Isolate policy can provide exclusive resources allotment to a VEE so that only that particular VEE or host can own set of RMID/CLOS. In Table 1, Index #1, 2 represents an Isolate policy example. Index #1 shows that RMID “0” and CLOS “0” are reserved for the host/VMM and will not be allocated to any guest (e.g., VEE). Index #2 shows another example of an Isolate policy where RMID (1, 2) and CLOS (1) are exclusively allocated to VM #1 for feature set CMT and CAT only.

Oversubscribe policy can enforce RMID/CLOS sharing among various VEEs. In Table 1, Index #3, 5 shows RMIDs and CLOSs are shared between VEE #2 and VEE #3. A difference between VEE #2 and VEE #3 is they have different set of technologies supported.

Combination policy can provide a combination of Isolation and Oversubscribe policy. A VEE can subscribe to such policy for exclusive construct with some non-exclusive construct. In Table 1, Index #6, shows RMID(5,6) are non-exclusive meaning they are being shared with VEEs #2, 3 but CLOS(4) is exclusive to VEE #4 only. Also, VEE #4 shows utilizes broader subset of features.

In other examples, CLOS can encompass allocation of one or more of: cache allocation, memory allocation, storage allocation, memory bandwidth, accelerator allocation, processor allocation, xPU allocation, or other device or software allocation.

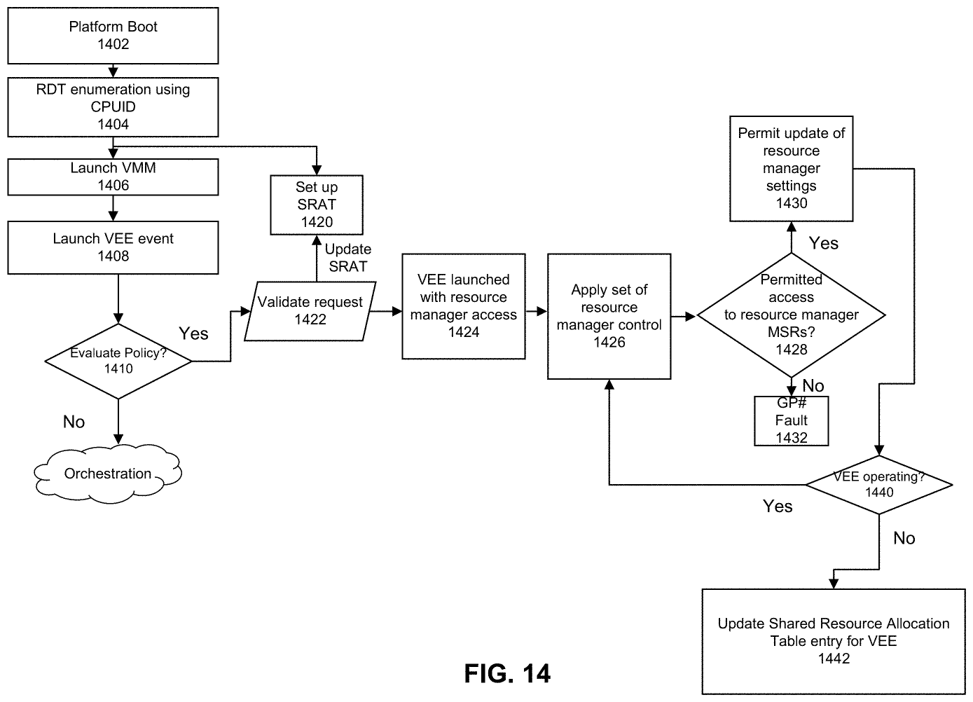

FIG. 14 depicts an example process. At 1402, in response to platform boot to an operating system (OS), at 1404, the user space software or OS can enumerate capabilities on the host using a CPUID instruction. At 1404, in order to take advantage of virtualized resource manager feature, a Virtual Machine Manager (VMM) can be exposed or populated with at least some resource manager capabilities. At 1420, software defined Shared Resource Allocation Table (SRAT) can be generated. A SRAT can hold information regarding resource manager constructs with regard to VEE, guest and host environment along with various policies that VEE can subscribe to. In some examples, SRAT can specify or limit sharing of constructs like RMIDs and CLOSs across multiple VEEs to limit an amount of resources a VEE can allocate. At 1408, a launch VEE event can either make orchestration to make request to launch VEE or guest VEE is launched locally on host machine.

At 1410, a determination can be made if a policy for the VEE is to be evaluated. If so, the process can proceed to 1422. Otherwise, the process can proceed to the orchestration in order to evaluate the policy for changes or updates.

At 1422, a Virtual Machine Control Structure (VMCS) can be accessed to provide an infrastructure configuration to determine permitted RMID and CLOS per VEE. VMCS can indicate allocated resources such as RMID and CLOS and features of a resource manager, such as CMT, CAT, MBM, etc., when CPUID enumeration is executed in VEE. At 1420, in some examples, VMCS can update entries in SRAT based on a successful VEE launch event, for example, if the VMCS changes any entries in the SRAT. At 1424, the VEE can be launched with access to configuration of the resource manager. At 1426, a VEE can configure resource manager. For example, after a VEE acquires resource manager capabilities, it can use either user space utilities or resctrl file system to access MSR allocated to the resource manager. At 1428, a determination can be made if the access to the resource manager is permitted. Access to the resource manager can be permitted if the RMID and CLOS values are within a permitted range for the particular VEE. For permitted access, the process can continue to 1430. Access to the resource manager may be denied if the RMID or CLOS values are not within a permitted range for the particular VEE. For non-permitted access, the process can continue to 1432.

At 1430, the resource manager can be configured by the VEE. In some cases, a VM exit can be avoided while allowing a VEE to configure the resource manager by writing to one or more MSRs associated with the resource manager. In some examples, MSRs can be accessed to serve rdmsr or wrmsr operations for non-root privilege. In some examples, a VEE can run a daemon or process to monitor and allocate as a feedback loop without needing to VM exit for resource manager related operations. The process can continue to 1440.

At 1432, access to the MSRs can cause a general protection (GP #) fault, if non-root privilege access is not supported.

At 1440 and 1442, after a VEE ends or a VEE with allocated resources shuts down, resources such as RMIDs and CLOSs for the shutdown VEE can be freed. In some examples, the SRAT can be updated to indicate available resources after shutdown of a VEE. An SRAT entry for a particular VEE identifier can be removed.

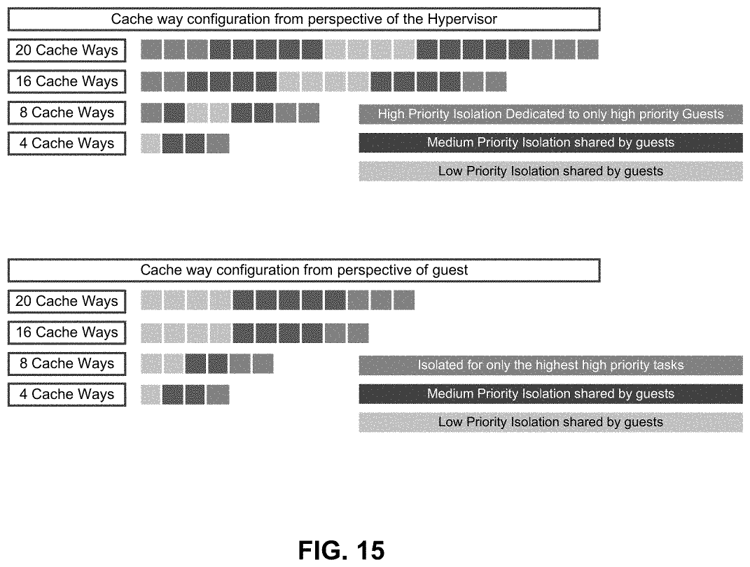

FIG. 15 depicts an example of cache way allocation using a resource manager. A VEE can request cache way allocation using embodiments described herein. Caches can also be configured in different schemes. One such cache configuration scheme is a set-associative cache. An associate scheme works by dividing the cache into multiple equal sections called cache ways. Each cache way is treated like a direct mapped cache for a memory location in the main memory. The cache ways can be grouped into sets to create a set-associative scheme, where each of the sets corresponds to a set of main memory locations. For example, a main memory can have 1000 memory locations and can be divided into four sets. A first set of the main memory locations can include locations 1-250, a second set of the main memory locations can include locations 251-500, and so forth. The set-associative cache can have 200 ways that can be grouped into 4 sets of 50 ways, where each set of ways corresponds to a set of main memory locations. For example, a first set of ways can include 50 ways in which data from any of the first set of the main memory locations (memory locations 1-250) can be stored. In another example, a first set of ways can include 50 ways in which data from any of a set of the main memory locations (e.g., memory locations 1, 5, 9, 13 . . . 993, 997) can be stored.

Cache ways can be limited resources similar to RMID and CLOS and can be maintained through the SRAT. The resources available to the guest can be accessible through CPUID. In some examples, the Guest uses CPUID Leaf 04H for retrieving L2 and L3 cache sizes and ways explicitly. Due to architectural constraints, cache way masks may be contiguous. This also makes shared cache ways more difficult to manage.

Cache ways can be remapped to a guest in various manners. In one example, a guest only receives isolated ways and can program one or more cache way masks to fit the demand. This is useful for lower amounts of consolidation where the granularity of cache ways required is reduced.

In some examples, a subset of cache ways can be shared given one of the following configurations based on cache ways available preventing any one guest from fully consuming the resources. This may allow some guarantee of increase priority in cache resources for a select few of guests that require either isolated cache ways or overall reduced sharing through medium priority ways. In some configurations, a guest with a highest priority configuration can determine that the most significant bit (MSB) of the CLOS way mask is likely the most isolated from other cores, while the least significant bit (LSB) is shared by cores. Therefore, if a high priority guest has a critical application, it can choose to consume the 4 highest priority ways, which in a 20 way platform, may experience very little thrashing (e.g., changes in contents of cache) from other applications. A medium priority guest may receive medium priority and low priority cache ways. A highest priority application in a medium priority guest can have little to no impact on the critical part of a high priority guest in terms of access to cache ways in this fashion. Reordering can be supported such that a system can have two very high priority guests with one having access to cache ways 1-12, and the second accesses 9-20. A manner in which ways are dedicated to each category of priority can be adjusted. In some examples, 25%-50%-25% split can be used for highest priority-medium priority-lowest priority.

An example of a static remapping table below can be applied to any set-way based caching structure including LLC, mid-level cache (MLC), and translation lookaside buffer (TLB) caches. A TLB can provide a translation of memory addresses from one domain to another domain.

TABLE 2

| | | Host | | |
|---|---|---|---|---|
| Index# | Priority | Cache Ways | Guest | VM# |
| 1 | Low | 9-12 | 1-4 | 1 |
| 2 | Medium | 12-4 | 1-9 | 2 |
| 3 | Medium | 9-17 | 1-9 | 3 |
| 4 | High | 9-20 | 1-12 | 4 |
| 5 | High | 12-1 | 1-12 | 5 |

In some examples, cache ways can be shared and communicated to a guest in a fashion that the guest can decide how many ways of cache to use. A translator or VEE can receive each MSR write to the way masks MSR and attempt to select a set of ways that are shared or isolated based on a guest's priority.

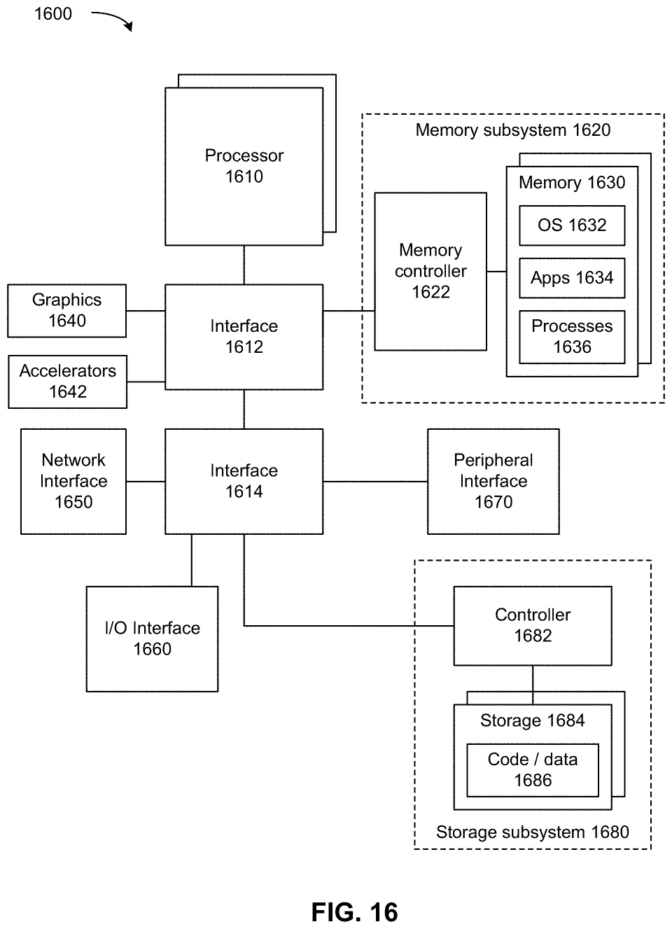

FIG. 16 depicts an example system. Various embodiments can be used by system 1600 to utilize resource allocation by a VEE using embodiments described herein. System 1600 includes processor 1610, which provides processing, operation management, and execution of instructions for system 1600. Processor 1610 can include any type of microprocessor, central processing unit (CPU), graphics processing unit (GPU), processing core, or other processing hardware to provide processing for system 1600, or a combination of processors. Processor 1610 controls the overall operation of system 1600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1600 includes interface 1612 coupled to processor 1610, which can represent a higher speed interface or a high throughput interface for system components that needs higher bandwidth connections, such as memory subsystem 1620 or graphics interface components 1640, or accelerators 1642. Interface 1612 represents an interface circuit, which can be a standalone component or integrated onto a processor die. Where present, graphics interface 1640 interfaces to graphics components for providing a visual display to a user of system 1600. In one example, graphics interface 1640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1640 generates a display based on data stored in memory 1630 or based on operations executed by processor 1610 or both. In one example, graphics interface 1640 generates a display based on data stored in memory 1630 or based on operations executed by processor 1610 or both.

Accelerators 1642 can be a fixed function or programmable offload engine that can be accessed or used by a processor 1610. For example, an accelerator among accelerators 1642 can provide compression (DC) capability, cryptography services such as public key encryption (PKE), cipher, hash/authentication capabilities, decryption, or other capabilities or services. In some embodiments, in addition or alternatively, an accelerator among accelerators 1642 provides field select controller capabilities as described herein. In some cases, accelerators 1642 can be integrated into a CPU socket (e.g., a connector to a motherboard or circuit board that includes a CPU and provides an electrical interface with the CPU). For example, accelerators 1642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1620 represents the main memory of system 1600 and provides storage for code to be executed by processor 1610, or data values to be used in executing a routine. Memory subsystem 1620 can include one or more memory devices 1630 such as read-only memory (ROM), flash memory, one or more varieties of random access memory (RAM) such as DRAM, or other memory devices, or a combination of such devices. Memory 1630 stores and hosts, among other things, operating system (OS) 1632 to provide a software platform for execution of instructions in system 1600. Additionally, applications 1634 can execute on the software platform of OS 1632 from memory 1630. Applications 1634 represent programs that have their own operational logic to perform execution of one or more functions. Processes 1636 represent agents or routines that provide auxiliary functions to OS 1632 or one or more applications 1634 or a combination. OS 1632, applications 1634, and processes 1636 provide software logic to provide functions for system 1600. In one example, memory subsystem 1620 includes memory controller 1622, which is a memory controller to generate and issue commands to memory 1630. It will be understood that memory controller 1622 could be a physical part of processor 1610 or a physical part of interface 1612. For example, memory controller 1622 can be an integrated memory controller, integrated onto a circuit with processor 1610.

In some examples, OS 1632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, OS 1632 can determine a capability of a device associated with a device driver. For example, OS 1632 can receive an indication of a capability of a device (e.g., a resource manager (not depicted)). OS 1632 can request a driver to enable or disable resource manager to perform any of the capabilities described herein. In some examples, OS 1632, itself, can enable or disable resource manager to perform any of the capabilities described herein. OS 1632 can provide requests (e.g., from an application or VEE) to a resource manager to allocate resources. For example, any application can request use or non-use of any of capabilities described herein by a resource manager.

While not specifically illustrated, it will be understood that system 1600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1600 includes interface 1614, which can be coupled to interface 1612. In one example, interface 1614 represents an interface circuit, which can include standalone components and integrated circuitry. In one example, multiple user interface components or peripheral components, or both, couple to interface 1614. Network interface 1650 provides system 1600 the ability to communicate with remote devices (e.g., servers or other computing devices) over one or more networks. Network interface 1650 can include an Ethernet adapter, wireless interconnection components, cellular network interconnection components, USB (universal serial bus), or other wired or wireless standards-based or proprietary interfaces. Network interface 1650 can transmit data to a device that is in the same data center or rack or a remote device, which can include sending data stored in memory. Network interface 1650 can receive data from a remote device, which can include storing received data into memory. Various embodiments can be used in connection with network interface 1650, processor 1610, and memory subsystem 1620. Various embodiments of network interface 1650 use embodiments described herein to receive or transmit timing related signals and provide protection against circuit damage from misconfigured port use while providing acceptable propagation delay.

In one example, system 1600 includes one or more input/output (I/O) interface(s) 1660. I/O interface 1660 can include one or more interface components through which a user interacts with system 1600 (e.g., audio, alphanumeric, tactile/touch, or other interfacing). Peripheral interface 1670 can include any hardware interface not specifically mentioned above. Peripherals refer generally to devices that connect dependently to system 1600. A dependent connection is one where system 1600 provides the software platform or hardware platform or both on which operation executes, and with which a user interacts.

In one example, system 1600 includes storage subsystem 1680 to store data in a nonvolatile manner. In one example, in certain system implementations, at least certain components of storage 1680 can overlap with components of memory subsystem 1620. Storage subsystem 1680 includes storage device(s) 1684, which can be or include any conventional medium for storing large amounts of data in a nonvolatile manner, such as one or more magnetic, solid state, or optical based disks, or a combination. Storage 1684 holds code or instructions and data 1686 in a persistent state (i.e., the value is retained despite interruption of power to system 1600). Storage 1684 can be generically considered to be a “memory,” although memory 1630 is typically the executing or operating memory to provide instructions to processor 1610. Whereas storage 1684 is nonvolatile, memory 1630 can include volatile memory (i.e., the value or state of the data is indeterminate if power is interrupted to system 1600). In one example, storage subsystem 1680 includes controller 1682 to interface with storage 1684. In one example controller 1682 is a physical part of interface 1614 or processor 1610 or can include circuits or logic in both processor 1610 and interface 1614.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache. A memory subsystem as described herein may be compatible with a number of memory technologies, such as DDR3 (Double Data Rate version 3, original release by JEDEC (Joint Electronic Device Engineering Council) on Jun. 16, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 1600. More specifically, power source typically interfaces to one or multiple power supplies in system 1600 to provide power to the components of system 1600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

FIG. 17 depicts an environment 1700 includes multiple computing racks 1702, each including a Top of Rack (ToR) switch 1704, a pod manager 1706, and a plurality of pooled system drawers. The environment can provide resource manager access to a VEE in accordance with embodiments described herein. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® Xeon® processor pooled computer drawer 1708, and Intel® ATOM™ processor pooled compute drawer 1710, a pooled storage drawer 1712, a pooled memory drawer 1714, and a pooled I/O drawer 1716. Each of the pooled system drawers is connected to ToR switch 1704 via a high-speed link 1718, such as an Ethernet link and/or a Silicon Photonics (SiPh) optical link.

Multiple of the computing racks 1702 may be interconnected via their ToR switches 1704 (e.g., to a pod-level switch or data center switch), as illustrated by connections to a network 1720. In some embodiments, groups of computing racks 1702 are managed as separate pods via pod manager(s) 1706. In one embodiment, a single pod manager is used to manage racks in the pod. Alternatively, distributed pod managers may be used for pod management operations.

Environment 1700 further includes a management interface 1722 that is used to manage various aspects of the environment. This includes managing rack configuration, with corresponding parameters stored as rack configuration data 1724. In an example, environment 1700 can be implemented using interconnected compute sleds of processors, memories, storages, network interfaces, and other components.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, edge servers, edge switches, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” “logic,” “circuit,” or “circuitry.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes a method comprising: providing range-limited capability to a virtualized execution environment to reserve one or more device resources by writing to a register independent from causing a virtual machine exit to request one or more device resources.

Example 2 includes any example, and includes determining if content written to the register corresponds to a permitted range of content for the virtualized execution environment.

Example 3 includes any example, wherein the content comprise a Resource Monitoring ID (RMID) and class of service (CLOS) and wherein the permitted range comprises a permitted range of RMIDs and CLOSs.

Example 4 includes any example, and includes a central processing unit (CPU) or XPU detecting a writing content to the register and determining if the content is within the permitted range.

Example 5 includes any example, wherein processor-executed microcode determines if the content is within a permitted range.

Example 6 includes any example, and includes using a remapping table to remap the content and determining if the remapped content is within the permitted range.

Example 7 includes any example, wherein the remapping table comprises a Virtual Machine Control Structure (VMCS) and the VMCS includes a pool of RMID values and CLOS values available for allocation to one or more virtualized execution environments.

Example 8 includes any example, and includes based on the content not being within the permitted range, invoking a virtual machine manager (VMM) to handle a fault.

Example 9 includes any example, wherein the reserve one or more device resources comprises writing a Resource Monitoring ID (RMID) and class of service (CLOS) to the register and wherein the CLOS indicates a resource allocation.

Example 10 includes any example, wherein the one or more device resources comprise one or more of: cache allocation or memory bandwidth.

Example 11 includes any example, and includes instructions stored thereon, that if executed by one or more processors, cause the one or more processors to: based on a request from a virtualized execution environment to reserve one or more device resources being within a permitted range, selectively transfer the request to reserve one or more device resources independent from causing a virtual machine exit to request to reserve one or more device resources, wherein the transfer comprises a write to a register.

Example 12 includes any example, comprising instructions stored thereon, that if executed by one or more processors, cause the one or more processors to: determine if content of the request from the virtualized execution environment corresponds to a permitted range of content for the virtualized execution environment.

Example 13 includes any example, wherein the content comprise a Resource Monitoring ID (RMID) and class of service (CLOS).

Example 14 includes any example, and includes comprising instructions stored thereon, that if executed by one or more processors, cause the one or more processors to: apply a remapping table to remap the content and determine if the remapped content is within the permitted range.

Example 15 includes any example, wherein the remapping table comprises a Virtual Machine Control Structure (VMCS) and the VMCS includes a pool of Resource Monitoring ID (RMID) values and class of service (CLOS) values available for allocation to one or more virtualized execution environments.

Example 16 includes any example, wherein the instructions comprise processor-executed microcode.

Example 17 includes any example, wherein the device resources comprise one or more of: cache allocation or memory bandwidth.

Example 18 includes any example, and includes an apparatus comprising: one or more processors, that when operational, are to: based on content in a request being within a permitted range for a virtualized execution environment, transfer the request from the virtualized execution environment to reserve one or more device resources independent from causing a virtual machine exit to request to reserve one or more device resources.

Example 19 includes any example, wherein the transfer comprises a write to a register.

Example 20 includes any example, wherein processor-executed microcode is to determine whether content in the request is within a permitted range for the virtualized execution environment.

Example 21 includes any example, wherein the content comprise a Resource Monitoring ID (RMID) and class of service (CLOS).

Example 22 includes any example, and includes one or more of a server, rack of servers, or data center, wherein the one or more of a server, rack of servers, or data center comprise one or more cache or memory device that is allocated to the virtualized execution environment based on the request.

What is claimed is:

1. A method comprising:
providing range-limited capability to a virtualized execution environment to reserve one or more device resources by writing to a register independent from causing a virtual machine exit to request one or more device resources.

2. The method of claim 1, comprising:
determining if content written to the register corresponds to a permitted range of content for the virtualized execution environment.

3. The method of claim 2, wherein the content comprise a Resource Monitoring ID (RMID) and class of service (CLOS) and wherein the permitted range comprises a permitted range of RMIDs and CLOSs.

4. The method of claim 2, comprising:
a central processing unit (CPU) or XPU detecting a writing content to the register and determining if the content is within the permitted range.

5. The method of claim 2, wherein processor-executed microcode determines if the content is within a permitted range.

6. The method of claim 2, comprising:
using a remapping table to remap the content and
determining if the remapped content is within the permitted range.

7. The method of claim 6, wherein the remapping table comprises a Virtual Machine Control Structure (VMCS) and the VMCS includes a pool of RMID values and CLOS values available for allocation to one or more virtualized execution environments.

8. The method of claim 2, comprising:
based on the content not being within the permitted range, invoking a virtual machine manager (VMM) to handle a fault.

9. The method of claim 1, wherein the reserve one or more device resources comprises writing a Resource Monitoring ID (RMID) and class of service (CLOS) to the register and wherein the CLOS indicates a resource allocation.

10. The method of claim 1, wherein the one or more device resources comprise one or more of: cache allocation or memory bandwidth.

11. A computer-readable medium comprising instructions stored thereon, that if executed by one or more processors, cause the one or more processors to:
based on a request from a virtualized execution environment to reserve one or more device resources being within a permitted range, selectively transfer the request to reserve one or more device resources independent from causing a virtual machine exit to request to reserve one or more device resources, wherein the transfer comprises a write to a register.

12. The computer-readable medium of claim 11, comprising instructions stored thereon, that if executed by one or more processors, cause the one or more processors to:
determine if content of the request from the virtualized execution environment corresponds to a permitted range of content for the virtualized execution environment.

13. The computer-readable medium of claim 12, wherein the content comprise a Resource Monitoring ID (RMID) and class of service (CLOS).

14. The computer-readable medium of claim 12, comprising instructions stored thereon, that if executed by one or more processors, cause the one or more processors to:
apply a remapping table to remap the content and
determine if the remapped content is within the permitted range.

15. The computer-readable medium of claim 14, wherein the remapping table comprises a Virtual Machine Control Structure (VMCS) and the VMCS includes a pool of Resource Monitoring ID (RMID) values and class of service (CLOS) values available for allocation to one or more virtualized execution environments.

16. The computer-readable medium of claim 11, wherein the instructions comprise processor-executed microcode.

17. The computer-readable medium of claim 11, wherein the device resources comprise one or more of: cache allocation or memory bandwidth.

18. An apparatus comprising:
one or more processors, that when operational, are to:
based on content in a request being within a permitted range for a virtualized execution environment, transfer the request from the virtualized execution environment to reserve one or more device resources independent from causing a virtual machine exit to request to reserve one or more device resources.

19. The apparatus of claim 18, wherein the transfer comprises a write to a register.

20. The apparatus of claim 18, wherein processor-executed microcode is to determine whether content in the request is within a permitted range for the virtualized execution environment.

21. The apparatus of claim 18, wherein the content comprise a Resource Monitoring ID (RMID) and class of service (CLOS).

22. The apparatus of claim 18, comprising one or more of a server, rack of servers, or data center, wherein the one or more of a server, rack of servers, or data center comprise one or more cache or memory device that is allocated to the virtualized execution environment based on the request.
